SEQUENCE LISTING (11 sequences)

SEQ ID NO: 1 - DNA, 29 bp, Synthetic construct
  source 1..29: mol_type = other DNA
  modified_base 23: mod_base = OTHER; note = uracil
aatgatacggcgaccaccgagatctacac

SEQ ID NO: 2 - DNA, 29 bp, Synthetic construct
  source 1..29: mol_type = other DNA
  modified_base 23: mod_base = OTHER; note = alkene-thymidine
aatgatacggcgaccaccgaganctacac

SEQ ID NO: 3 - DNA, 29 bp, Synthetic construct
  source 1..29: mol_type = other DNA
  modified_base 23: mod_base = i
aatgatacggcgaccaccgaganctacac

SEQ ID NO: 4 - DNA, 24 bp, Synthetic construct
  source 1..24: mol_type = other DNA
  modified_base 22: mod_base = OTHER; note = 8-oxoguanine
caagcagaagacggcatacganat

SEQ ID NO: 5 - DNA, 24 bp, Synthetic construct
  source 1..24: mol_type = other DNA
  modified_base 20: mod_base = OTHER; note = 8-oxoguanine
caagcagaagacggcatacnagat

SEQ ID NO: 6 - DNA, 24 bp, synthetic construct
  source 1..24: mol_type = other DNA
  modified_base 20: mod_base = OTHER; note = 8-oxoguanine
  modified_base 22: mod_base = OTHER; note = 8-oxoguanine
caagcagaagacggcatacnanat

SEQ ID NO: 7 - DNA, 29 bp, Synthetic construct
  source 1..29: mol_type = other DNA
  modified_base 23: mod_base = OTHER; note = allyl-T
aatgatacggcgaccaccgaganctacac

SEQ ID NO: 8 - DNA, 35 bp, Synthetic construct
  source 1..35: mol_type = other DNA
gctggcacgtccgaacgcttcgttaatccgttgag

SEQ ID NO: 9 - DNA, 35 bp, Synthetic construct
  source 1..35: mol_type = other DNA
cgtcgtctgccatggcgcttcggtggatatgaact

SEQ ID NO: 10 - DNA, 35 bp, Synthetic construct
  source 1..35: mol_type = other DNA
acggccgctaatatcaacgcgtcgaatccgcaact

SEQ ID NO: 11 - DNA, 34 bp, Synthetic construct
  source 1..34: mol_type = other DNA
gccgcgttacgttagccggactattcgatgcagc

(19) United States
(12) Patent Application Publication
(10) Pub. No.: US 2025/0235867 A1
(43) Pub. Date: Jul. 24, 2025

(54) FLOW CELLS

(71) Applicant: ILLUMINA, INC., San Diego, CA (US)

(72) Inventors: Clayton Braga, San Diego, CA (US); Tyler Dill, San Diego, CA (US); Dennis Doucet, Encinitas, CA (US); Ryan McCurdy, San Diego, CA (US)

(21) Appl. No.: 18/986,337

(22) Filed: Dec. 18, 2024

Related U.S. Application Data
(60) Provisional application No. 63/612,975, filed on Dec. 20, 2023.

(51) Int. Cl. B01L 3/00

(52) U.S. Cl. CPC B01L 3/502784; B01L 3/502707; B01L 2300/0663; B01L 2300/16; B01L 2400/0424

(57) ABSTRACT

A flow cell includes a substrate that has both an active region and an inactive region. The active region is defined in a portion of the substrate, and includes: a plurality of first depressions defined in the portion of the substrate; and surface chemistry positioned in the plurality of first depressions. The inactive region is defined in another portion of the substrate that is adjacent to the active region, and the inactive region includes: at least one row of second depressions defined in the substrate; and an unpatterned fluidic pinning region positioned between the at least one row and an edge of the active region. The unpatterned fluidic pinning region has a predetermined width.

### CROSS-REFERENCE TO RELATED APPLICATIONS

This application claims the benefit of U.S. Provisional Application Ser. No. 63/612,975, filed Dec. 20, 2023, the contents of which is incorporated by reference herein in its entirety.

### REFERENCE TO SEQUENCE LISTING

The instant application contains a Sequence Listing, which has been submitted electronically in XML file format and is hereby incorporated by reference in its entirety. Said XML copy, created on Dec. 16, 2024 is named ILI269B_IP-2696-US_Sequence_Listing.xml and is 14,873 bytes in size.

### BACKGROUND

Various protocols in biological or chemical research involve performing a large number of controlled reactions on local support surfaces or within predefined reaction chambers of a flow cell. The reactions may then be observed or detected, and subsequent analysis may help identify or reveal properties of molecules involved in the controlled reactions. In some examples, the reactions generate fluorescence, and thus an optical system that is configured for fluorescence detection may be used to analyze the controlled reactions. In other examples, the controlled reactions alter charge, conductivity, or some other electrical property, and thus an electronic system may be used for detection.

### SUMMARY

Polymer-coated substrates are used in many biotechnological applications. As an example, a portion of a flow cell may include a substrate surface having a polymer coating thereon, which can be used for the preparation and/or analysis of biological molecules. Molecular analyses, such as certain nucleic acid sequencing methods, may operate using nucleic acid strands that are attached to the polymer-coated substrate surface. The architecture of the substrate surface disclosed herein includes a pinning region that enables the deposition of the polymer coating in a desired region with a high degree of precision. This excludes the coating from other areas of the flow cell where exclusion is desired, such as bonding regions of the flow cell. In turn, nucleic acid strands that are attached or are to be attached to the polymer coating are positioned in desirable areas of the flow cell.

Protective coatings may also be applied on the polymer-coated substrate surface (e.g., at an active region of the substrate) to protect the surface until the surface and the components thereon are ready to be used in nucleic acid sequencing methods. The protective coating is applied using the methods disclosed herein, and the pinning region enables the deposition of the protective coating in a particular region, e.g., where protection/passivation is desired, with a high degree of precision.

Overall, flow cells that include the pinning region and that have been coated with various materials using the high precision coating techniques disclosed herein may: reduce scrap and waste during flow cell manufacturing (e.g., by reducing bonding defects), improve consistency of results across different flow cell sequencing operations, and improve flow cell throughput by eliminating gutter regions (i.e., regions of unused flow cell surface area that are otherwise included, in part, to accommodate for natural process variation and skew in sequencing laser). Without gutter regions, the overall flow cell size may be reduced. Further, the flow cells and methods described herein may improve the compatibility of various fluids with wafer chemistry processes and enable a higher density of usable area.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1A is a top view of an example flow cell;

FIG. 1B is an enlarged, partially cutaway, cross-sectional, and perspective view of an example of an active region of the flow cell;

FIG. 1C is an enlarged, partially cutaway, cross-sectional, and perspective view of an inactive region of the flow cell including at least one row of depressions and an unpatterned fluidic pinning region;

FIG. 2 depicts a schematic illustration of a complementary metal-oxide semiconductor imaging device that is coupled to a substrate;

FIG. 3A through FIG. 3E are schematic views that illustrate an example of a high precision method of applying a polymeric hydrogel within an active region of a substrate, where FIG. 3A depicts different sets of depressions that are respectively defined within an active region and an inactive region of a substrate, FIG. 3B depicts applying a polymeric hydrogel over the active region and a portion of the inactive region, FIG. 3C depicts the spreading of the polymeric hydrogel further into the inactive region and the pinning of the polymeric hydrogel at an interface separating the inactive region and the active region, FIG. 3D depicts removing the polymeric hydrogel from interstitial regions of the active region and from the inactive region, and FIG. 3E depicts primers that are grafted to the polymeric hydrogel within the active region;

FIG. 4A through FIG. 4D are schematic views that illustrate an example of a high precision method of applying a protective coating solution over an active region of a substrate having surface chemistry applied therein, where FIG. 4A depicts applying the protective coating solution in the active region, FIG. 4B depicts the coating solution spreading further into the inactive region, FIG. 4C depicts drying or curing of the protective coating solution to form a protective coating, and FIG. 4D depicts the selective removal of the protective coating from portions of the substrate; and

FIG. 5 is a schematic illustration of a precision gantry tool that can be used in an example of a method disclosed herein.

### Definitions

It is to be understood that terms used herein will take on their ordinary meaning in the relevant art unless specified otherwise. Several terms used herein and their meanings are set forth below.

The singular forms “a”, “an”, and “the” include plural referents unless the context clearly dictates otherwise.

The terms comprising, including, containing and various forms of these terms are synonymous with each other and are meant to be equally broad.

The terms top, bottom, lower, upper, on, adjacent, etc. are used herein to describe the flow cell and/or the various components of the flow cell. It is to be understood that these directional terms are not meant to imply a specific orientation, but are used to designate relative orientation between components. The use of directional terms should not be interpreted to limit the examples disclosed herein to any specific orientation(s).

The terms first, second, etc. also are not meant to imply a specific orientation or order, but rather are used to distinguish one component from another.

An “acrylamide monomer” refers to a monomer with the structure

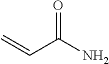

or a monomer including an acrylamide group. Examples of the monomer including an acrylamide group include azido acetamido pentyl acrylamide:

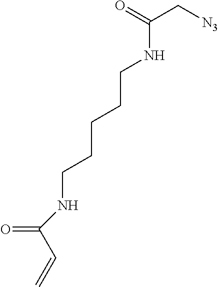 [SMILES: C=CC(=O)NCCCCCNC(=O)CN=[N+]=[N-]]

### and N-isopropylacrylamide:

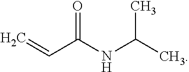

Other acrylamide monomers may be used.

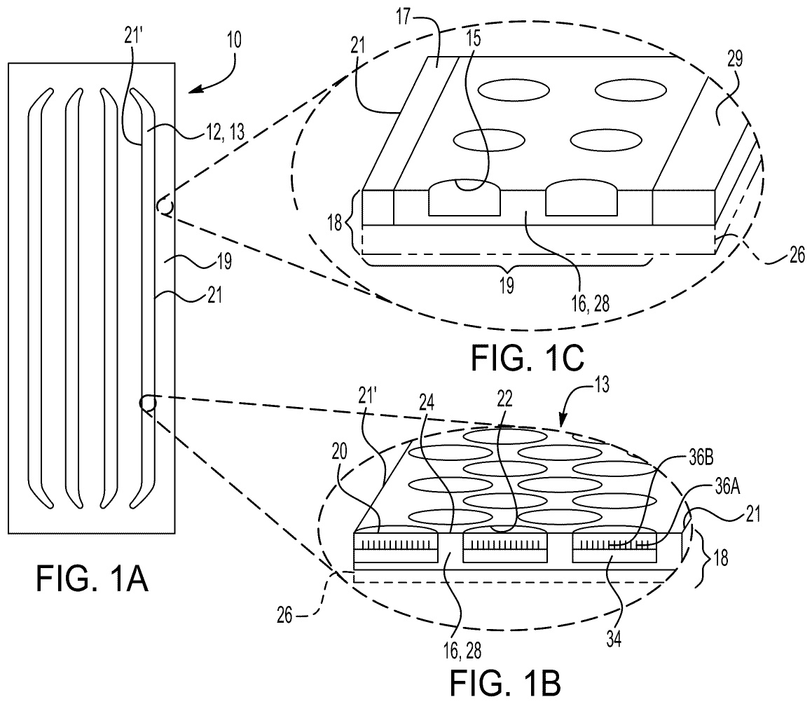

The terms “active area” or “active region” refer to the region of a substrate where a reaction can be carried out. During fabrication of the flow cell, the active area may include a polymeric hydrogel that is capable of attaching primers (or that has primers attached thereto) and that can participate in nucleic acid template amplification. One or more active region(s) may be in fluid communication with a flow channel (see FIG. 1B, which shows an active region 13 in fluid communication with a corresponding flow channel 12). In some examples disclosed herein, such as when an open-wafer substrate is used, one or more (discrete) active regions may define a single flow channel.

The term “activation,” as used herein, refers to a process that generates reactive groups at the surface of a single layer substrate or an outermost layer of a multi-layered substrate. Activation may be accomplished using silanization or plasma ashing. Though not explicitly shown in the figures, when activation of a surface is performed, it is to be understood that silane groups or —OH functional groups become introduced to the surface. These functional groups can then be used to covalently attach a material, such as a polymeric hydrogel, to the surface that includes the functional groups.

An “aldehyde,” as used herein, refers to an organic compound containing a functional group with the structure —CHO, which includes a carbonyl center (i.e., a carbon double-bonded to oxygen), with the carbon atom also being bonded to hydrogen and an R group (such as an alkyl or other side chain). The general structure of an aldehyde is:

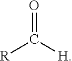

As used herein, “alkyl” refers to a straight or branched hydrocarbon chain that is fully saturated (i.e., contains no double or triple bonds). The alkyl group may have 1 to 20 carbon atoms. Example alkyl groups include methyl, ethyl, propyl, isopropyl, butyl, isobutyl, tertiary butyl, pentyl, hexyl, and the like. As an example, the designation “C1-4 alkyl” indicates that there are one to four carbon atoms in the alkyl chain, i.e., the alkyl chain is selected from the group consisting of methyl, ethyl, propyl, iso-propyl, n-butyl, isobutyl, sec-butyl, and tert-butyl.

As used herein, “alkenyl” refers to a straight or branched hydrocarbon chain containing one or more double bonds. The alkenyl group may have 2 to 20 carbon atoms. Example alkenyl groups include ethenyl, propenyl, butenyl, pentenyl, hexenyl, and the like.

As used herein, “alkyne” or “alkynyl” refers to a straight or branched hydrocarbon chain containing one or more triple bonds. The alkynyl group may have 2 to 20 carbon atoms.

As used herein, “aryl” refers to an aromatic ring or ring system (i.e., two or more fused rings that share two adjacent carbon atoms) containing only carbon in the ring backbone. When the aryl is a ring system, every ring in the system is aromatic. The aryl group may have 6 to 18 carbon atoms. Examples of aryl groups include phenyl, naphthyl, azulenyl, and anthracenyl.

An “amino” functional group refers to an —NRₐR_{b} group, where Rₐ and R_{b} are each independently selected from hydrogen

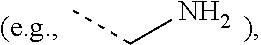

C1-6 alkyl, C2-6 alkenyl, C2-6 alkynyl, C3-7 carbocycle, C6-10 aryl, 5-10 membered heteroaryl, and 5-10 membered heterocycle, as defined herein.

As used herein, the term “attached” refers to the state of two things being joined, fastened, adhered, connected or bound to each other, either directly or indirectly. For example, a nucleic acid can be attached to a polymeric hydrogel by a covalent or non-covalent bond. A covalent bond is characterized by the sharing of pairs of electrons between atoms. A non-covalent bond is a physical bond that does not involve the sharing of pairs of electrons and can include, for example, hydrogen bonds, ionic bonds, van der Waals forces, hydrophilic interactions, and hydrophobic interactions. As another example, in enclosed versions of the flow cell disclosed herein, a lid may be attached to a patterned structure (e.g., at a bonding region).

An “azide” or “azido” functional group refers to —N₃.

As used herein, a “bonding region” refers to an area of a substrate that is to be bonded to another material, which may be, as examples, a spacer layer, a lid, another substrate, etc., or combinations thereof (e.g., a spacer layer and a lid, or a spacer layer and another substrate). The bond that is formed at the bonding region may be a chemical bond (as described above), or a mechanical bond (e.g., using a fastener, etc.). The bonding region is free of surface chemistry (e.g., polymeric hydrogel and primers of a primer set), and exclusion of the surface chemistry from the bonding region may be facilitated, in part, by the high precision coating methods disclosed herein.

As used herein, “carbocycle” means a non-aromatic cyclic ring or ring system containing only carbon atoms in the ring system backbone. When the carbocycle is a ring system, two or more rings may be joined together in a fused, bridged or spiro-connected fashion. Carbocycles may have any degree of saturation, provided that at least one ring in a ring system is not aromatic. Thus, carbocycles include cycloalkyls, cycloalkenyls, and cycloalkynyls. The carbocycle group may have 3 to 20 carbon atoms. Examples of carbocycle rings include cyclopropyl, cyclobutyl, cyclopentyl, cyclohexyl, cyclohexenyl, 2,3-dihydro-indene, bicyclo[2.2.2]octanyl, adamantyl, and spiro[4.4]nonanyl.

As used herein, the term “carboxylic acid” or “carboxyl” refers to —COOH.

As used herein, “cycloalkyl” refers to a completely saturated (no double or triple bonds) mono- or multi-cyclic hydrocarbon ring system. When composed of two or more rings, the rings may be joined together in a fused fashion. Cycloalkyl groups can contain 3 to 10 atoms in the ring(s). In some examples, cycloalkyl groups can contain 3 to 8 atoms in the ring(s). A cycloalkyl group may be unsubstituted or substituted. Example cycloalkyl groups include cyclopropyl, cyclobutyl, cyclopentyl, cyclohexyl, cycloheptyl, and cyclooctyl.

As used herein, “cycloalkenyl” or “cycloalkene” means a carbocycle ring or ring system having at least one double bond, wherein no ring in the ring system is aromatic. Examples include cyclohexenyl or cyclohexene and norbornenyl or norbornene. Also as used herein, “heterocycloalkenyl” or “heterocycloalkene” means a carbocycle ring or ring system with at least one heteroatom in ring backbone, having at least one double bond, wherein no ring in the ring system is aromatic.

As used herein, “cycloalkynyl” or “cycloalkyne” means a carbocycle ring or ring system having at least one triple bond, wherein no ring in the ring system is aromatic. An example is cyclooctyne. Another example is bicyclononyne. Also as used herein, “heterocycloalkynyl” or “heterocycloalkyne” means a carbocycle ring or ring system with at least one heteroatom in ring backbone, having at least one triple bond, wherein no ring in the ring system is aromatic.

The term “depositing,” as used herein, refers to any suitable application technique, which may be manual or automated, and, in some instances, results in modification of the surface properties. Generally, depositing may be performed using vapor deposition techniques, coating techniques, grafting techniques, or the like. Some specific examples include chemical vapor deposition (CVD), spray coating (e.g., ultrasonic spray coating), spin coating, dunk or dip coating, doctor blade coating, puddle dispensing, flow through coating/deposition, aerosol printing, screen printing, microcontact printing, inkjet printing, or the like. In one example, deposition is performed using a precision gantry tool.

As used herein, the term “depression” refers to a discrete concave feature defined in a substrate and having a surface opening. In some instances, the surface opening is at least partially surrounded by interstitial region(s) of the substrate. Depressions can have any of a variety of shapes at their opening in a surface including, as examples, round, elliptical, square, polygonal, star shaped (with any number of vertices), etc. The cross-section of a depression taken orthogonally with the surface can be curved, square, polygonal, hyperbolic, conical, angular, etc. As examples, the depression can be a well or two interconnected wells. In some examples disclosed herein, depression(s) are disposed within an active region of a flow cell and may include surface chemistry. These depressions are sometimes referred to herein as “first depressions.” In some other examples disclosed herein, depression(s) are disposed within an inactive region of a flow cell. In these examples, the depressions do not include surface chemistry and are used to coat/pin fluids (e.g., hydrogels, protective coatings) with a high degree of precision. These depressions are sometimes referred to herein as “second depressions.”

The term “each,” when used in reference to a collection of items, is intended to identify an individual item in the collection, but does not necessarily refer to every item in the collection. Exceptions can occur if explicit disclosure or context clearly dictates otherwise.

The term “epoxy” as used herein refers to

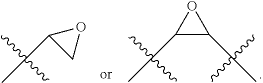

As used herein, the term “flow cell” is intended to refer to a vessel having an enclosed flow channel where a reaction can be carried out, or a vessel that is open to a surrounding environment and in which a reaction can be carried out. A flow cell with an enclosed channel also includes an inlet for delivering reagent(s) to the channel and an outlet for removing reagent(s) from the channel. In some examples, the flow cell enables the detection of the reaction that occurs therein. For example, the flow cell can include one or more transparent surfaces allowing for the optical detection of arrays, optically labeled molecules, or the like. As another example, the flow cell can include a complementary metal oxide semiconductor chip coupled thereto, allowing for the electrical detection of arrays, optically labeled molecules, or the like.

As used herein, a “flow channel” or “channel” may be an area defined between two bonded components. The “flow channel” or “channel” can selectively receive a liquid sample, reagents, etc. In some examples disclosed herein, the flow channel is defined between two patterned substrates, and the flow channel is in fluid communication with surface chemistry disposed within depressions on either of the two substrates. In other examples disclosed herein, the flow channel is defined between one substrate and a lid, and the flow channel is in fluid communication with surface chemistry within depressions of the one substrate. Alternatively, the terms “flow channel” or “channel” may refer to a discrete area on a surface of an open-wafer substrate defined by one or more active regions, where the one or more active regions defining the flow channel can receive a liquid (sample).

As used herein, “fluid edge positional variation” refers to an amount of variability or deviation a fluid edge has over its length as measured from a target axis. With the method disclosed herein, the target axis spans the length of the flow cell and is determined by the pattern in the inactive region, the unpatterned fluidic pinning region, and the positioning of the tool used to dispense the fluid. The variation may be expressed as the greatest width between two points (and their corresponding axes that are parallel to the target axis) along the length of the fluid edge.

As used herein, “heteroaryl” refers to an aromatic ring or ring system (i.e., two or more fused rings that share two adjacent atoms) that contain(s) one or more heteroatoms, that is, an element other than carbon, including but not limited to, nitrogen, oxygen and sulfur, in the ring backbone. When the heteroaryl is a ring system, every ring in the system is aromatic. The heteroaryl group may have 5-18 ring members.

As used herein, “heterocycle” means a non-aromatic cyclic ring or ring system containing at least one heteroatom in the ring backbone. Heterocycles may be joined together in a fused, bridged or spiro-connected fashion. Heterocycles may have any degree of saturation provided that at least one ring in the ring system is not aromatic. In the ring system, the heteroatom(s) may be present in either a non-aromatic or aromatic ring. The heterocycle group may have 3 to 20 ring members (i.e., the number of atoms making up the ring backbone, including carbon atoms and heteroatoms). In some examples, the heteroatom(s) are O, N, or S.

The term “hydrazine” or “hydrazinyl” as used herein refers to a —NHNH₂ group.

The term “hydrazone” or “hydrazonyl,” as used herein, refers to a

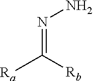

group in which Rₐ and R_{b} are each independently selected from hydrogen, C1-6 alkyl, C2-6 alkenyl, C2-6 alkynyl, C3-7 carbocycle, C6-10 aryl, 5-10 membered heteroaryl, and 5-10 membered heterocycle, as defined herein.

As used herein, “hydroxy” or “hydroxyl” refers to an —OH group.

The term “hydrogel” or “polymeric hydrogel” refers to a semi-rigid polymer that is permeable to liquids and/or gases. The hydrogel can swell when liquid (e.g., water) is taken up and that can contract when liquid is removed, e.g., by drying. While a hydrogel may absorb water, it is not water-soluble.

As used herein, the term “inactive region” refers to an area, e.g., of a substrate, that includes at least one row of depressions and an unpatterned fluidic pinning region, where the at least one row of depressions and the unpatterned fluidic pinning region are used to create differential surface energy that facilitates pinning of a fluid with a high degree of precision. The depressions within the inactive region are sometimes referred to herein as “second depressions.”

As used herein, the term “interstitial region” refers to an area, e.g., of a substrate that separates individual depressions within an active region of a flow cell from other depressions within the active region. Interstitial regions may also separate depressions that form at least one row within an inactive region from one another. The separation provided by an interstitial region can be partial or full separation.

“Nitrile oxide,” as used herein, means a “RₐC≡N⁺O⁻” group in which Rₐ is defined herein. Examples of preparing nitrile oxide include in situ generation from aldoximes by treatment with chloramide-T or through action of base on imidoyl chlorides [RC(Cl)═NOH] or from the reaction between hydroxylamine and an aldehyde.

“Nitrone,” as used herein, means a

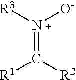

group in which R¹, R², and R³ may be any of the Rₐ and R_{b} groups defined herein, except that R³ is not hydrogen (H).

As used herein, a “nucleotide” includes a nitrogen-containing heterocyclic base, a sugar, and one or more phosphate groups. Nucleotides are monomeric units of a nucleic acid sequence. In RNA (ribonucleic acid), the sugar is a ribose, and in DNA (deoxyribonucleic acid), the sugar is a deoxyribose, i.e., a sugar lacking a hydroxyl group that is present at the 2′ position in ribose. The nitrogen containing heterocyclic base (i.e., nucleobase) can be a purine base or a pyrimidine base. Purine bases include adenine (A) and guanine (G), and modified derivatives or analogs thereof. Pyrimidine bases include cytosine (C), thymine (T), and uracil (U), and modified derivatives or analogs thereof. The C−1 atom of deoxyribose is bonded to N−1 of a pyrimidine or N−9 of a purine. A nucleic acid analog may have any of the phosphate backbone, the sugar, or the nucleobase altered. Examples of nucleic acid analogs include, for example, universal bases or phosphate-sugar backbone analogs, such as peptide nucleic acid (PNA).

In some examples, the term “over” may mean that one component or material is positioned directly on another component or material. When one is directly on another, the two are in physical contact with each other. In FIG. 1B, the layer 28 is applied over the base support 26 (when a multi-layer substrate 18 is utilized) so that the layer 28 is directly on and in contact with the base support 26.

In other examples, the term “over” may mean that one component or material is positioned indirectly on another component or material. By indirectly on, it is meant that a gap or an additional component or material may be positioned between the two components or materials. In FIG. 1B, when the multi-layer substrate 18 is utilized, the protective coating 20 is positioned over the base support 26 of the multi-layer substrate 18, such that the two are in indirect contact. More specifically, the protective coating 20 is indirectly over the base support 26 because the polymeric hydrogel 34 is positioned between the two components 26 and 20.

A “patterned structure” refers to a substrate that includes active region(s) and inactive region(s). In some examples, the substrate is exposed to patterning techniques (e.g., etching, lithography, etc.) in order to generate the pattern(s) within the active region(s) and the inactive region(s). However, the term “patterned structure” is not intended to imply that such patterning techniques have to be used to generate the pattern. The patterned structure may be generated via any of the methods disclosed herein.

As used herein, the term “polyhedral oligomeric silsesquioxane” (an example of which is commercially available under the tradename “POSS®”) refers to a chemical composition that is a hybrid intermediate (e.g., RSiO_{1.5}) between that of silica (SiO₂) and silicone (R₂SiO). An example of polyhedral oligomeric silsesquioxane may be that described in Kehagias et al., Microelectronic Engineering 86 (2009), pp. 776-778, which is incorporated by reference in its entirety. In an example, the composition is an organosilicon compound with the chemical formula [RSiO_{3/2}]ₙ, where the R groups can be the same or different. Example R groups for POSS® include epoxy, azide/azido, a thiol, a poly(ethylene glycol), a norbornene, a tetrazine, acrylates, and/or methacrylates, or further, for example, alkyl, aryl, alkoxy, and/or haloalkyl groups.

As used herein, the “primer” is defined as a single stranded nucleic acid sequence (e.g., single stranded DNA). Some primers, referred to herein as amplification primers, serve as a starting point for template amplification and cluster generation. Other primers, referred to herein as sequencing primers, serve as a starting point for DNA synthesis. The 5′ terminus of the primer may be modified to allow a coupling reaction with a functional group of a polymeric hydrogel. The primer length can be any number of bases long and can include a variety of non-natural nucleotides. In an example, the sequencing primer is a short strand, ranging from 10 to 60 bases, or from 20 to 40 bases.

As used herein, the term “protective coating” refers to a water-soluble material in the form of a solid (e.g., a thin film), or a gel, or a liquid that is applied on the active area of a substrate. The protective coating may be any water-soluble material that does not deleteriously affect the underlying surface chemistry or substrate and that serves to protect and/or preserve the functionality of the active area. A water-soluble protective coating is, by definition, distinguishable from a polymeric hydrogel, as the protective coating dissolves when exposed to water, and may be washed away in this manner; while the polymeric hydrogel is water-insoluble. The protective coating may at least substantially prevent a hydrogel layer (and primers attached thereto) from undergoing deleterious changes during processing and/or shipping and/or storage. For another example, the protective coating may preserve the accessibility of the primer and/or at least substantially prevent degradation of the polymeric hydrogel.

A “spacer layer,” as used herein refers to a material that bonds two components together. In some examples, the spacer layer can be a radiation-absorbing material that aids in bonding, or can be put into contact with a radiation-absorbing material that aids in bonding.

The term “substrate” may be used herein in conjunction with the term “single layer substrate” or “multi-layer substrate.” A single layer substrate is one layer of a support material that can be patterned with depressions (see, e.g., the substrate 16 depicted in FIG. 1B and FIG. 1C). The multi-layered substrate includes at least two layers, e.g., a base support with an additional layer thereon that can be patterned with depressions (see, e.g., the substrate 18 including the base support 26 and the layer 28 over the base support 26 depicted in FIG. 1B and FIG. 1C).

“Surface chemistry,” as defined herein, refers to a polymeric hydrogel (as defined herein) and at least one primer attached thereto. Surface chemistry may be positioned with depressions of an active region of a flow cell.

The term “tantalum pentoxide” refers to the inorganic compound with the formula Ta₂O₅. This compound is transparent, having a transmittance ranging from about 0.25 (25%) to 1 (100%), to wavelengths ranging from about 0.35 μm (350 nm) to at least 1.8 μm (1800 nm). A “tantalum pentoxide substrate” may comprise, consist essentially of, or consist of Ta₂O₅. In examples where it is desirable for the tantalum pentoxide substrate to transmit electromagnetic energy having any of these wavelengths, the substrate may consist of Ta₂O₅ or may comprise or consist essentially of Ta₂O₅ and other components that will not interfere with the desired transmittance of the substrate.

A “thiol” functional group refers to —SH.

As used herein, the terms “tetrazine” and “tetrazinyl” refer to six-membered heteroaryl group comprising four nitrogen atoms. Tetrazine can be optionally substituted.

“Tetrazole,” as used herein, refers to five-membered heterocyclic group including four nitrogen atoms. Tetrazole can be optionally substituted.

The term “transparent” when describing a material (e.g., substrate, layer, etc.) means that that the material allows light of a particular wavelength or range of wavelengths to pass through. Transparency may be quantified using transmittance, i.e., the ratio of light energy falling on a body to that transmitted through the body. The transmittance of a transparent material will depend upon the thickness of the material and the wavelength of light. In the examples disclosed herein, the transmittance of the transparent material may range from 0.25 (25%) to 1 (100%). The material may be a pure material, a material with some impurities, or a mixture of materials, as long as the resulting material is capable of the desired transmittance. Additionally, depending upon the transmittance of the material, the time for light exposure and/or the output power of the light source may be increased or decreased to deliver a suitable dose of light energy through the transparent material to achieve the desired effect.

As used herein, an “unpatterned fluidic pinning region” is a substantially planar area, e.g., of an inactive region of a substrate, that is used in combination with at least one row of depressions to create differential surface energy that facilitates high-precision fluidic pinning. Unpatterned fluidic pinning regions are free of depressions, do not include additional chemical modification, and have a predetermined width.

### DETAILED DESCRIPTION

Flow cells used in nucleic acid sequencing may include one or more substrates having (an) active region(s) where amplification, cluster generation, and sequencing can take place. In enclosed examples of the flow cells disclosed herein, the substrate may be bonded to a lid or to another substrate, e.g., at a bonding region, to create a flow channel for delivering reagents to the active region(s). In these examples, it is often desirable for the bonding region to be free of the materials included in the active region(s). In open-wafer examples of the flow cells disclosed herein, the substrate is not bonded to a lid or to another substrate (and thus does not include a bonding region), but the substrate still includes surface chemistry within one or more active region(s) of the substrate. In these examples, it is often desirable to deliver reagents within a particular active region, such that the reagents do not become applied in another (e.g., adjacent) active region.

Additionally, in any example of the flow cells disclosed herein, it may be desirable for the active area to be coated with a protective coating prior to shipping and/or storage. When the protective coating is utilized, it is generally desirable to deposit the coating where passivation/protection of underlying structures is desired (e.g., at active regions including surface chemistry) while excluding the protective coating from portions of the flow cell where passivation/protection is not desired.

The examples disclosed herein incorporate an inactive region adjacent to the active region that enables a desired chemistry (e.g., the polymeric hydrogel, the protective coating, primers, sequencing reagents, or the like) to be deposited to the active region with high precision. The structure of the flow cell and methods of forming the flow cell will now be described.

### Flow Cells and Flow Cell Formation

Examples of the flow cell disclosed herein generally comprise a (i) a substrate; (ii) an active region defined in a portion of the substrate, the active region including: a plurality of first depressions defined in a portion of the substrate; and surface chemistry positioned within the plurality of first depressions; and (iii) an inactive region defined in another portion of the substrate that is adjacent to the active region, the inactive region including: at least one row of second depressions defined in the substrate; and an unpatterned fluidic pinning region positioned between the at least one row (of depressions) and an edge of the active region, the unpatterned fluidic pinning region having a predetermined width.

FIG. 1A depicts an example of the flow cell 10 disclosed herein from a top view. The flow cell 10 includes the active region(s) 13 and the inactive region(s) 19 adjacent to each other. As depicted in FIG. 1A, the flow cell 10 includes alternating active and inactive regions 13, 19, 13, 19, etc. FIG. 1B depicts the architecture within the active region 13 of the flow cell 10. FIG. 1C depicts the architecture within the inactive region 19.

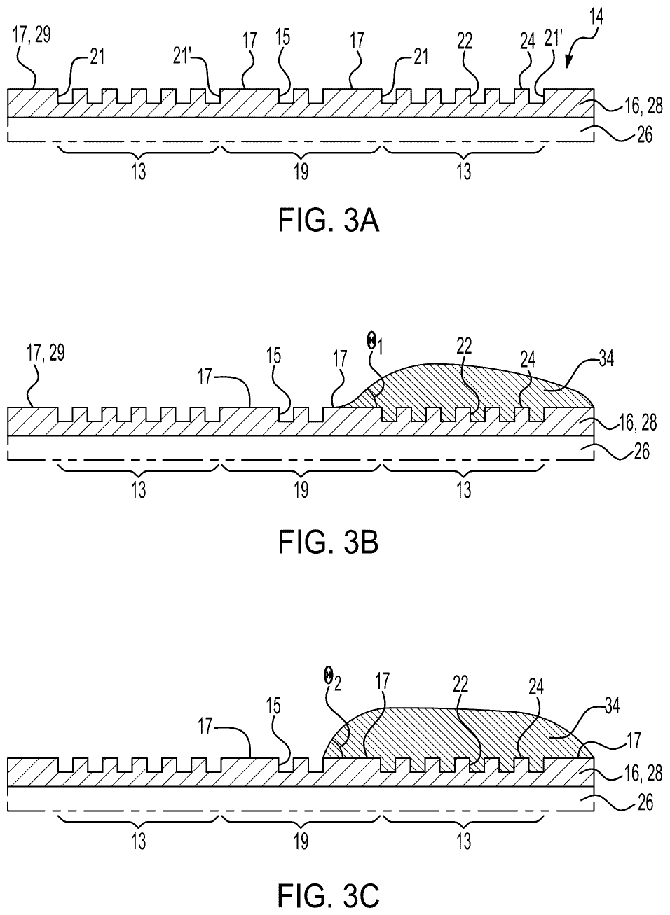

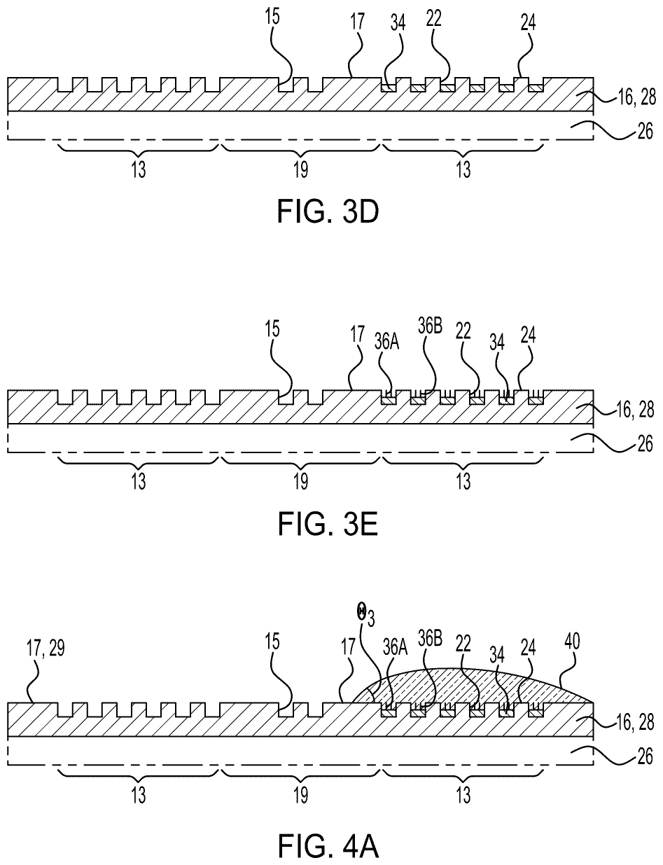

The active and inactive regions 13, 19 are defined in a patterned structure 14 (see FIG. 3A). Thus, FIG. 1B and FIG. 1C depict different portions A, B of the patterned structure 14.

Enclosed examples of the flow cell 10 disclosed herein may include one patterned structure 14 bonded to a lid (lid not shown), e.g., at a bonding region 29 (see FIG. 1C), or one patterned structure 14 bonded to a second patterned structure via a spacer layer at the bonding region 29 (second patterned structure and spacer layer not shown). Open-wafer examples of the flow cell 10 include a single patterned structure 14 that is open to the surrounding environment.

In enclosed versions of the flow cell 10, the spacer layer used to attach the patterned structure 14 and the lid or to the second patterned structure may be any material that will seal portions of the patterned structure 14 and the lid or that will seal portions of the patterned structure 14 and the second patterned structure. As examples, the spacer layer may be an adhesive, a radiation-absorbing material that aids in bonding, or the like. In some examples, the spacer layer is the radiation-absorbing material, e.g., KAPTON® black.

In both enclosed and open-wafer versions of the flow cell 10, the patterned structure 14 of the flow cell 10 may be a single layer substrate 16, or the patterned structure 14 may be a multi-layer substrate 18 including a base support 26 having a layer 28 positioned thereon.

Examples of suitable materials for the substrate 16 include siloxanes (e.g., epoxy siloxane), glass, modified or functionalized glass, polymeric materials (including acrylics, polystyrene and copolymers of styrene and other materials, polypropylene, polyethylene, polybutylene, polyurethanes, polytetrafluoroethylene (such as TEFLON® from Chemours), polyethylene terephthalate (PET), polycarbonate, cyclic olefins/cyclo-olefin polymers (COP) (such as ZEONOR® from Zeon), polyimides, nylon (polyamides), etc.), ceramics/ceramic oxides, silica (i.e., silicon dioxide (SiO₂)), fused silica, or silica-based materials, aluminum silicate, silicon and modified silicon (e.g., boron doped p+ silicon), silicon nitride (Si₃N₄), tantalum pentoxide (Ta₂O₅) or other tantalum oxide(s) (TaOₓ), hafnium oxide (HfO₂), carbon, metals, resins, or the like. Examples of suitable resins include inorganic oxides, such as tantalum pentoxide (e.g., Ta₂O₅) or other tantalum oxide(s) (TaOₓ), aluminum oxide (e.g., Al₂O₃), silicon oxide (e.g., SiO₂), hafnium oxide (e.g., HfO₂), indium tin oxide, titanium dioxide, etc., or polymeric resins, such as a polyhedral oligomeric silsesquioxane based resin (e.g., POSS® from Hybrid Plastics), a non-polyhedral oligomeric silsesquioxane epoxy resin, a poly(ethylene glycol) resin, a polyether resin (e.g., ring opened epoxies), an acrylic resin, an acrylate resin, a methacrylate resin, an amorphous fluoropolymer resin (e.g., CYTOP® from Bellex), and combinations thereof. It is to be understood that the material of the substrate 16 may be any material that can be etched or imprinted to form the (first) depressions 22 shown in FIG. 1B (e.g., within the active region 13 of the flow cell 10) and the (second) depressions 15 shown in FIG. 1C (e.g., within the inactive region 19 of the flow cell 10).

As mentioned, examples of the multi-layer substrate 18 include the base support 26 and at least one other layer 28 positioned thereon. Any example of the material of the single layer substrate 16 may be used as the base support 26 of the multi-layer substrate 18. Examples of suitable materials for the layer 28 include inorganic oxides, such as tantalum oxide (e.g., Ta₂O₅), aluminum oxide (e.g., Al₂O₃), silicon oxide (e.g., SiO₂), or hafnium oxide (e.g., HfO₂), or polymeric resins, such as a polyhedral oligomeric silsesquioxane based resin (e.g., POSS® from Hybrid Plastics), a non-polyhedral oligomeric silsesquioxane epoxy resin, a poly(ethylene glycol) resin, a polyether resin (e.g., ring opened epoxies), an acrylic resin, an acrylate resin, a methacrylate resin, an amorphous fluoropolymer resin (e.g., CYTOP® from Bellex), and combinations thereof. It is to be understood that in examples of the flow cell 10 that include the substrate 18, the other layer 28 (positioned on the base support 26) may be any material that can be etched or imprinted to form depressions 22 (e.g., within the active region 13 of the flow cell 10) and depressions 15 (e.g., within the inactive region 19 of the flow cell 10).

Suitable deposition techniques for the material of the substrate 16 or for the materials of the components of the substrate 18 (e.g., the base support 26 and the layer 28) include chemical vapor deposition, dip coating, dunk coating, spin coating, spray coating, puddle dispensing, ultrasonic spray coating, doctor blade coating, aerosol printing, screen printing, microcontact printing, etc. It is to be understood that the deposition technique(s) that is/are used may depend, in part, upon the material of the substrate 16 or the material of the components of the substrate 18.

Suitable patterning techniques for the material of the substrate 16 or for the layer 28 of the substrate 18 include photolithography, nanoimprint lithography (NIL), stamping techniques, embossing techniques, molding techniques, microetching techniques, etc. It is to be understood that the patterning technique(s) that is/are used may depend, in part, upon the material used for the substrate 16 or for the layer 28 of the substrate 18. A specific example of a method of forming the depressions 22, 15 is described in more detail in regard to FIG. 3A through FIG. 3E.

The single layer substrate 16 or the base support 26 (of the multi-layer substrate 18) may be a circular sheet, a panel, a wafer, a die etc. having a diameter ranging from about 2 mm to about 300 mm, e.g., from about 200 mm to about 300 mm, or may be a rectangular sheet, panel, wafer, die etc. having its largest dimension up to about 10 feet (˜3 meters). For example, a die may have a width ranging from about 0.1 mm to about 10 mm. While example dimensions have been provided, it is to be understood that a substrate 16 or base support 26 with any suitable dimensions may be used.

The thickness of the layer 28 (when the substrate 18 is used) is greater than the desired depth for the depressions 22, 15 formed therein.

The enclosed flow cells 10 include a flow channel 12. In the enclosed flow cells 10, the flow channel(s) 12 is/are defined between the one patterned structure 14 and the lid or between the one patterned structure 14 and the second patterned structure, which are bonded together via the spacer layer. Thus, the flow channel(s) 12 in the enclosed form of the flow cell 10 is/are defined by the patterned structure 14, the spacer layer, and either the lid or the second patterned structure. Alternatively, examples of the open-wafer flow cell 10 include the single patterned structure 14. In these examples, the substrate 16 or 18 (of the structure 14) is a planar surface having the active and inactive regions 13, 19 defined therein. In examples utilizing the open-wafer flow cell 10, any fluids (including sequencing reagents) are introduced via the high precision coating methods described herein.

The depth of the flow channel 12 in the enclosed versions of the flow cell 10 can be as small as a monolayer thick when microcontact, aerosol, or inkjet printing is used to deposit a separate material (e.g., the spacer layer) that defines at least a portion of the sidewalls of the flow channel 12. This depth could be thicker if the spacer layer is pre-formed or applied via another technique. For other examples, the depth of the flow channel 12 can be about 1 μm, about 10 μm, about 50 μm, about 100 μm, or more. In an example, the depth may range from about 10 μm to about 400 μm. In another example, the depth may range from about 10 μm to about 30 μm. In still another example, the depth is about 5 μm or less. It is to be understood that the depth of the flow channel 12 may be greater than, less than or between the values specified above.

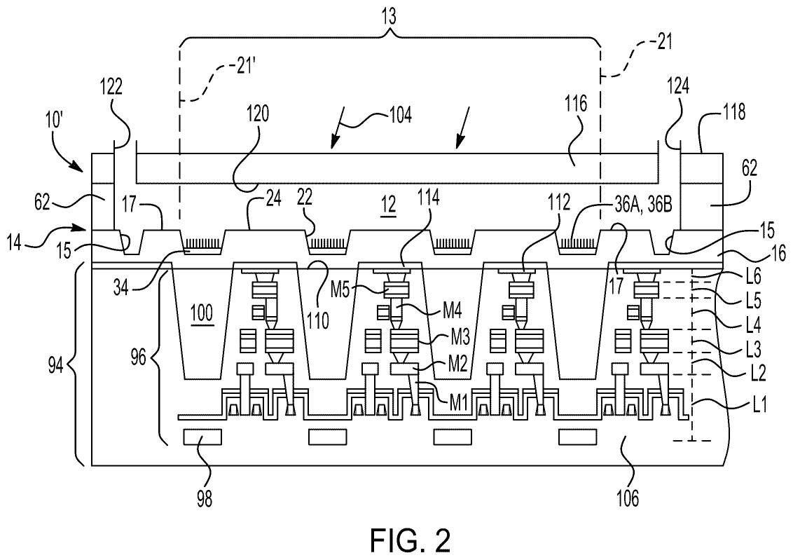

Each flow channel 12 that is included in enclosed versions of the flow cell 10 may be in fluid communication with an inlet and an outlet (examples of which are shown at reference numerals 122, 124 in FIG. 2). The inlet and outlet 122, 124 of each flow channel 12 may be positioned at opposed ends of the flow cell 10. The inlets and outlets 122, 124 of the respective flow channels 12 may alternatively be positioned anywhere along the length and width of the flow channel 12 that enables desirable fluid flow.

In the enclosed versions of the flow cell 10, the inlet 122 allows fluid(s) to be introduced into the flow channel 12, and the outlet 124 allows fluid(s) to be extracted from the flow channel 12. Each of the inlet(s) 122 and outlet(s) 124 is/are fluidly connected to a fluidic control system (including, e.g., reservoirs, pumps, valves, waste containers, and the like) that controls fluid introduction and expulsion. Some examples of the fluids that may be introduced into the flow channel(s) 12 include reaction components (e.g., DNA sample, polymerases, sequencing primers, nucleotides, etc.), washing solutions, deblocking agents, protective coating removers, etc.

The example flow cell 10 shown in FIG. 1A includes four active regions 13, which in some examples define and/or are in fluid communication with respective flow channels 12. While four active regions 13 are shown in FIG. 1A, it is to be understood that any number of active regions 13 may be included in the flow cell 10 (e.g., a single active region 13, eight active regions 13, etc.). In some instances, for each active region 13 that is included, an equivalent number of flow channels 12 may also be present. Alternatively, in other instances (and as described in regard to the methods disclosed herein), multiple active regions 13 may be present within (or may define) respective, distinct portions of a single flow channel 12.

The flow channels 12 (when included) may have any desirable shape. In an example, the flow channel 12 (and the corresponding active region(s) 13 shown in FIG. 1A) has a substantially rectangular configuration with curved ends. The length of the flow channel(s) 12 depends, in part, upon the size of the substrate (e.g., 16 or 18, see FIG. 1B and FIG. 1C) used to form the patterned structure 14. The width of the flow channel(s) 12 depends, in part, upon the size of the substrate 16 or 18 used to form the patterned structure 14, the desired number of flow channel(s) 12, the desired number of depressions 22 within an individual flow channel 12, the dimensions of the inactive region(s) 19 adjacent to the flow channel(s) 12, and the desired space at a perimeter of the patterned structure 14. The inactive region 19 between active regions 13 and the bonding region 29 at the perimeter of the patterned structure 14 may be sufficient for attachment to a lid (not shown) or to a second patterned structure (also not shown).

The individual active regions 13 may also have any desirable shape, which may be controlled using the methods described herein.

FIG. 1B shows a substrate 16, 18 including a plurality of first depressions 22 having surface chemistry therein, where the depressions 22 are included as part of an active region 13. As further shown in FIG. 1B, the surface chemistry includes the polymeric hydrogel 34 having primers 36A and 36B grafted thereto. Each of the first depressions 22 within the active region 13 is separated from each other first depression 22 within the active region 13 by interstitial regions 24. The interstitial regions 24 are free of the hydrogel 34 (and of the primers 36A, 36B). As will be described in more detail in regard to the method depicted in FIG. 3A through FIG. 3E, in some instances, the portion of the substrate 16, 18 including the plurality of first depressions 22 is silanized. In these instances, the silanization (or activation) of the active region 13 of the flow cell 10 facilitates attachment of the surface chemistry (e.g., the polymeric hydrogel 34) to the surface of the substrate 16, 18.

Each active region 13 that is included in the flow cell 10 has opposed edges 21, 21′ that are respectively adjacent to an inactive region 19. The edges 21, 21′ are respectively defined between the outermost depressions 22 in the active region 13 and the portion of the substrate 16 or 18 that defines the unpatterned fluidic pinning region 17 of the inactive region 19. The edges 21, 21′ extend along a length of the substrate 16, 18 and are substantially parallel to the unpatterned fluidic pinning region 17.

The inactive region 19 that is adjacent to one edge 21 of the active region 13 (shown in FIG. 1B) is depicted in FIG. 1C. As shown in FIG. 1C, the inactive region 19 includes at least one row of second depressions 15 defined in the substrate 16 (or layer 28 of the substrate 18) and an unpatterned fluidic pinning region 17 positioned between the at least one row of second depressions 15 and the edge 21 of the active region 13. The at least one row of second depressions 15 extends the length of the substrate 16 or 18 and is substantially parallel to the edge 21. While FIG. 1C depicts an inactive region 19 that includes two rows of (second) depressions 15, it is to be understood that any number of rows of depressions 15 may be included in the inactive region 19 (e.g., three rows, five rows, ten rows, fifty rows, hundreds of rows, etc.). As such, the width of the portion of the inactive region 19 including the depressions 15 may vary depending, in part, upon the number of rows and the spacing between the rows. In one example, the width of the portion of the inactive region 19 including the depressions 15 is about 4 μm, and ten rows of depressions 15 are included.

FIG. 1C depicts the inactive region 19 directly adjacent to the bonding region 29 of the flow cell 10. It is to be understood, however, that when the inactive region 19 separates two active regions 13 (see, e.g., FIG. 3A through FIG. 3C), the inactive region 19 includes the rows of depressions 15 flanked on either side by a respective unpatterned fluidic pinning region 17.

The unpatterned fluidic pinning region 17 is defined by a substantially planar surface of the substrate 16 or 18. As such, the unpatterned fluidic pinning region 17 does not include depressions 15 or any other physical pattern defined therein. The unpatterned fluidic pinning region 17 has a predetermined width. In an example, the predetermined width of the unpatterned fluidic pinning region 17 ranges from about 3 μm to about 200 μm. In another example, the predetermined width of the unpatterned fluidic pinning region 17 ranges from about 40 μm to about 100 μm. In one specific example, the predetermined width of the unpatterned fluidic pinning region 17 is about 70 μm.

The inactive region 19 also has a predetermined width, which is defined by the width of the portion of the inactive region 19 including the depressions 15 and the predetermined width of the unpatterned fluidic pinning region 17.

When multiple active regions 13 are included in the flow cell 10 (e.g., within/to define a single flow channel 12 or within/to define different flow channels 12), each active region 13 may be isolated from another active region 13 so that fluid introduced into one active region 13 does not flow into (an) adjacent active region(s) 13. In some examples, one active region 13 is flanked on either side by two respective, distinct inactive regions 19. As illustrated in FIG. 3A, the individual inactive region 19 includes respective unpatterned fluidic pinning regions 17 directly adjacent to the edges 21, 21′ of the active region 13 and further includes the rows of depressions 15 between the two pinning regions 17). In these examples, the differential surface energy created across the active region 13 and the directly adjacent inactive region 19 facilitates the fluidic isolation of the one active region 13 from (an) adjacent active region(s) 13. In other examples (see FIG. 1C), the inactive region 19 facilitates the physical isolation of the active region 13 from the bonding region 29 of the flow cell 10. In these examples, the inactive region 19 facilitates the fluidic isolation of the active region 13 from the bonding region 29 by creating differential surface energy across the active region 13 and the inactive region 19. The creation/presence of differential surface energy between the active region 13 and the inactive region(s) 19 is described in more detail herein in regard to method shown in FIG. 3A through FIG. 3E.

The depressions 15, 22 may be respectively formed in the inactive region 19 and in the active region 13 using any suitable patterning technique, such as stamping, nanoimprint lithography, photolithography, etching, etc.

Many different layouts of the first depressions 22 within the active region 13 may be envisaged, including regular, repeating, and non-regular patterns. In an example, the first depressions 22 are disposed in a hexagonal grid for close packing and improved density. Other layouts may include, for example, rectilinear (rectangular) layouts, triangular layouts, and so forth. In some examples, the layout or pattern can be an x-y format in rows and columns. In other examples, the layout or pattern can be a repeating arrangement of first depressions 22 and the interstitial regions 24. In still other examples, the layout or pattern can be a random arrangement of the first depressions 22.

The layout of the second depressions 15 within the inactive region 19 is a single row or several rows that are evenly spaced from one another across a width of the inactive region 19.

The layout or pattern of first depressions 22 within the active region 13 and of the second depressions 15 in the at least one row within the inactive region 19 may be characterized with respect to the density (number) of the depressions 15, 22 in a defined area. For example, the depressions 15, 22 may be present at a density of approximately 2 million per mm². The density may be tuned to different densities including, for example, a density of about 100 per mm², about 1,000 per mm², about 0.1 million per mm², about 1 million per mm², about 2 million per mm², about 5 million per mm², about 10 million per mm², about 50 million per mm², or more, or less. It is to be further understood that the density can be between one of the lower values and one of the upper values selected from the ranges above, or that other densities (outside of the given ranges) may be used. As examples, a high density array may be characterized as having the depressions 15, 22 separated by less than about 100 nm, a medium density array may be characterized as having the depressions 15, 22 separated by about 400 nm to about 1 μm, and a low density array may be characterized as having the depressions 15, 22 separated by greater than about 1 μm.

The layout or pattern of the depressions 15, 22 may also or alternatively be characterized in terms of the average pitch, or the spacing from the center of one depression 15, 22 to the center of an immediately adjacent depression 15, 22. The pattern can be regular, such that the coefficient of variation around the average pitch is small, or the pattern can be non-regular in which case the coefficient of variation can be relatively large. In either case, the average pitch can be, for example, about 50 nm, about 0.15 μm, about 0.5 μm, about 1 μm, about 5 μm, about 10 μm, about 100 μm, or more or less. The average pitch for a particular pattern of depressions 15, 22 can be between one of the lower values and one of the upper values selected from the ranges herein. It is to be understood that the pitch of the depressions 22 in the active region 13 may be the same as or different than the pitch of the depressions 15 in the inactive region 19. In an example, the pitch may be narrower in the inactive region 19 than in the active region 13.

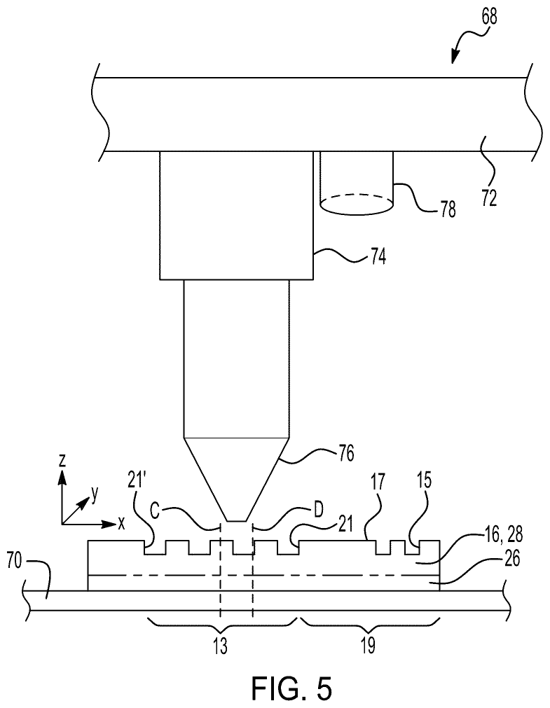

In an example, the depressions 15, 22 have a pitch (center-to-center spacing) of about 1.5 μm. In another example, each second depression 15 in the at least one row of second depressions 15 is separated from another second depression 15 in the at least one row of second depressions 15 by a pitch ranging from about 350 nm to about 650 nm. As will be described in more detail in regard to the description of FIG. 5, the pitch of the second depressions 15 in the inactive region 19 may be tuned to facilitate fluidic pinning. While example average pitch values have been provided, it is to be understood that other average pitch values may be used.

The size of each depression 15, 22 may be characterized by its volume, opening area, depth, and/or diameter or length and width. For example, the volume can range from about 1×10⁻³ μm³ to about 100 μm³, e.g., about 1×10⁻² μm³, about 0.1 μm³, about 1 μm³, about 10 μm³, or more, or less. For another example, the opening area can range from about 1×10⁻³ μm² to about 100 μm², e.g., about 1×10⁻² μm², about 0.1 μm², about 1 μm², at least about 10 μm², or more, or less. For still another example, the depth can range from about 0.1 μm to about 100 μm, e.g., about 0.5 μm, about 1 μm, about 10 μm, or more, or less. For another example, the depth can range from about 0.1 μm to about 100 μm, e.g., about 0.5 μm, about 1 μm, about 10 μm, or more, or less. For yet another example, the diameter or each of the length and width can range from about 0.1 μm to about 100 μm, e.g., about 0.5 μm, about 1 μm, about 10 μm, or more, or less. As such, in a specific example, each second depression 15 in the at least one row of second depressions 15 has a diameter ranging from about 0.1 μm to about 100 μm. It is to be understood that the volume, opening area, depth, and/or diameter or length and width of the depressions 22 in the active region 13 may be the same as or different than, respectively, the volume, opening area, depth, and/or diameter or length and width of the depressions 15 in the inactive region 19.

As described, each of the plurality of first depressions 22 included in the active region 13 of the flow cell 10 has surface chemistry applied therein, and the surface chemistry includes the polymeric hydrogel 34 and the primers 36A, 36B attached thereto. It is to be understood that in some instances, the at least one row of second depressions 15 of the inactive region 19 is free of the polymeric hydrogel 34.

The polymeric hydrogel 34 may be any gel material that can swell when liquid is taken up and that can contract when liquid is removed, e.g., by drying. In an example, the polymeric hydrogel 34 includes an acrylamide copolymer, such as poly N-(5-azidoacetamidylpentyl)acrylamide-co-acrylamide, PAZAM. PAZAM and some other forms of the acrylamide copolymer are represented by the following structure (I):

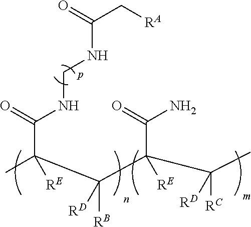

wherein:
R^{A} is selected from the group consisting of azido, optionally substituted amino, optionally substituted alkenyl, optionally substituted alkyne, halogen, optionally substituted hydrazone, optionally substituted hydrazine, carboxyl, hydroxy, optionally substituted tetrazole, optionally substituted tetrazine, nitrile oxide, nitrone, sulfate, and thiol;
R^{B} is H or optionally substituted alkyl;
R^{C}, R^{D}, and R^{E} are each independently selected from the group consisting of H and optionally substituted alkyl;
each of the —(CH₂)ₚ— can be optionally substituted;
p is an integer in the range of 1 to 50;
n is an integer in the range of 1 to 50,000; and
m is an integer in the range of 1 to 100,000.

One of ordinary skill in the art will recognize that the arrangement of the recurring “n” and “m” features in structure (I) are representative, and the monomeric subunits may be present in any order in the polymer structure (e.g., random, block, patterned, or a combination thereof).

The molecular weight of PAZAM and other forms of the acrylamide copolymer may range from about 5 kDa to about 1500 kDa or from about 10 kDa to about 1000 kDa. In a specific example, the molecular weight of the acrylamide copolymer is about 312 kDa.

In some examples, PAZAM and other forms of the acrylamide copolymer are linear polymers. In some other examples, PAZAM and other forms of the acrylamide copolymer are lightly cross-linked polymers.

In other examples, the gel material may be a variation of the structure (I). In one example, the acrylamide unit may be replaced with N,N-dimethylacrylamide

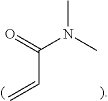

In this example, the acrylamide unit in structure (I) may be replaced with

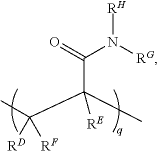

where R^{D}, R^{E}, and R^{F} are each H or a C1-C6 alkyl, and R^{G} and R^{H} are each a C1-C6 alkyl (instead of H as is the case with the acrylamide). In this example, q may be an integer in the range of 1 to 100,000. In another example, the N,N-dimethylacrylamide may be used in addition to the acrylamide unit. In this example, structure (I) may include

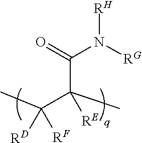

in addition to the recurring “n” and “m” features, where R^{D}, R^{E}, and R^{F} are each H or a C1-C6 alkyl, and R^{G} and R^{H} are each a C1-C6 alkyl. In this example, q may be an integer in the range of 1 to 100,000.

As another example of the polymeric hydrogel 34, the recurring “n” feature in structure (I) may be replaced with a monomer including a heterocyclic azido group having structure (II):

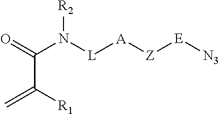

wherein R¹ is H or a C1-C6 alkyl; R₂ is H or a C1-C6 alkyl; L is a linker including a linear chain with 2 to 20 atoms selected from the group consisting of carbon, oxygen, and nitrogen and 10 optional substituents on the carbon and any nitrogen atoms in the chain; E is a linear chain including 1 to 4 atoms selected from the group consisting of carbon, oxygen and nitrogen, and optional substituents on the carbon and any nitrogen atoms in the chain; A is an N substituted amide with an H or a C1-C4 alkyl attached to the N; and Z is a nitrogen containing heterocycle. Examples of Z include 5 to 10 carbon-containing ring members present as a single cyclic structure or a fused structure. Some specific examples of Z include pyrrolidinyl, pyridinyl, or pyrimidinyl.

As still another example, the polymeric hydrogel 34 may include a recurring unit of each of structure (III) and (IV):

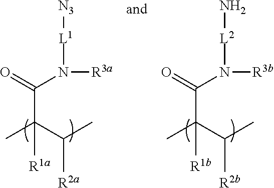

wherein each of R^{1a}, R^{2a}, R^{1b} and R^{2b} is independently selected from hydrogen, an optionally substituted alkyl or optionally substituted phenyl; each of R^{3a} and R^{3b} is independently selected from hydrogen, an optionally substituted alkyl, an optionally substituted phenyl, or an optionally substituted C7-C14 aralkyl; and each of L¹ and L² is independently selected from an optionally substituted alkylene linker or an optionally substituted heteroalkylene linker.

It is to be understood that other polymeric hydrogels 34 may be used, provided that the hydrogels are suitable for grafting oligonucleotide primers 36A, 36B thereto. Some additional examples of suitable materials for the polymeric hydrogel 34 include functionalized polysilanes, such as norbornene silane, azido silane, alkyne functionalized silane, amine functionalized silane, maleimide silane, or any other polysilane having functional groups that can attach the desired primer set 36A, 36B. Other examples of suitable polymeric hydrogels 34 include those having a colloidal structure, such as agarose; or a polymer mesh structure, such as gelatin; or a cross-linked polymer structure, such as polyacrylamide polymers and copolymers, silane free acrylamide (SFA), or an azidolyzed version of SFA. Examples of suitable polyacrylamide polymers may be synthesized from acrylamide and an acrylic acid or an acrylic acid containing a vinyl group, or from monomers that form [2+2] photo-cycloaddition reactions. Still other examples of suitable polymeric hydrogels include mixed copolymers of acrylamides and acrylates. A variety of polymer architectures containing acrylic monomers (e.g., acrylamides, acrylates etc.) may be utilized in the examples disclosed herein, such as branched polymers, including dendrimers, and the like. For example, the monomers (e.g., acrylamide, etc.) may be incorporated, either randomly or in block, into the branches (arms) of a dendrimer.

The polymeric hydrogel 34 may be formed using any suitable copolymerization process and may be deposited using any of the methods disclosed herein. For at least some of the deposition techniques, the polymeric hydrogel 34 may be incorporated into a mixture, e.g., with water or with ethanol and water, and then applied within the plurality of first depressions 22. A high-precision method of coating the polymeric hydrogel 34 within the first depressions 22 of the active region 13 (e.g., that utilizes the inactive region 19 to aid in controlling the deposition) is described in more detail herein in regard to FIG. 3A through FIG. 3E.

The attachment of the polymeric hydrogel 34 to the substrate 16 or to the layer 28 of the multi-layer substrate 18 may be through covalent bonding. As described, in some instances, the substrate 16 or the layer 28 may first be activated, e.g., through silanization or plasma ashing, to facilitate the attachment of the polymeric hydrogel 34 thereto. Covalent linking is helpful for maintaining the primers 36A, 36B in the active region(s) 13 throughout the lifetime of the flow cell 10 during a variety of uses.

As shown in FIG. 1B, the polymeric hydrogel 34 has the primer(s) 36A, 36B attached thereto.

A grafting process may be performed to graft the primers 36A, 36B to the polymeric hydrogel 34 either before or after the polymeric hydrogel 34 is deposited in accordance with the examples set forth herein. When the primers 36A, 36B are attached to the polymeric hydrogel 34 before the hydrogel is deposited, the hydrogel is referred to as being “pre-grafted.”

In an example, the primers 36A, 36B may be amplification primers. In this example, the amplification primers 36A, 36B can be immobilized to the polymeric hydrogel 34 by single point covalent attachment at or near the 5′ end of the primers 36A, 36B. This attachment leaves i) an adapter-specific portion of the primers 36A, 36B free to anneal to its cognate sequencing-ready nucleic acid fragment and ii) the 3′ hydroxyl group free for primer extension. Any suitable covalent attachment may be used for this purpose. Examples of terminated primers that may be used include alkyne terminated primers (e.g., which may attach to an azide surface moiety of the polymeric hydrogel 34), or azide terminated primers (e.g., which may attach to an alkyne surface moiety of the polymeric hydrogel 34), or phospho-thioate terminated primers (e.g., which may attach to a bromine surface moiety of the polymeric hydrogel 34).

The primer set includes two different primers 36A, 36B that are used in sequential paired end sequencing. As examples, the primer set may include P5 and P7 primers, P15 and P7 primers, or any combination of the PA primers, the PB primers, the PC primers, and the PD primers set forth herein. As examples, the primer set may include any two PA, PB, PC, and PD primers, or any combination of one PA primer and one PB, PC, or PD primer, or any combination of one PB primer and one PC or PD primer, or any combination of one PC primer and one PD primer.

Specific examples of suitable primers 36A, 36B include P5 and P7 primers used on the surface of commercial flow cells sold by Illumina Inc. for sequencing on HISEQ™, HISEQX™, MISEQ™, MISEQDX™, MINISEQ™, NEXTSEQ™, NEXTSEQDX™, NOVASEQ™, GENOME ANALYZER™, ISEQ™, and other instrument platforms.

The P5 primer (shown as a cleavable primer due to the cleavable nucleobase uracil, alkene-thymidine, or inosine) is:

P5 #1: 5′ → 3′
(SEQ. ID. NO. 1)
AATGATACGGCGACCACCGAGAUCTACAC;
or
P5 #2: 5′ → 3′
(SEQ. ID. NO. 2)
AATGATACGGCGACCACCGAGAnCTACAC
where “n” is alkene-thymidine (i.e., alkene-dT);
or
P5 #3: 5′ → 3′
(SEQ. ID. NO. 3)
AATGATACGGCGACCACCGAGAnCTACAC
where “n” is inosine.

The P7 primer (shown as cleavable primers) may be any of the following:

P7 #1: 5′ → 3′
(SEQ. ID. NO. 4)
CAAGCAGAAGACGGCATACGAnAT
where “n” is 8-oxoguanine;
P7 #2: 5′ → 3′
(SEQ. ID. NO. 5)
CAAGCAGAAGACGGCATACnAGAT
where “n” is 8-oxoguanine;
P7 #3: 5′ → 3′
(SEQ. ID. NO. 6)
CAAGCAGAAGACGGCATACnAnAT
where each “n” is 8-oxoguanine.

The P15 primer (shown as a cleavable primer) is:

P15: 5′ → 3′
(SEQ. ID. NO. 7)
AATGATACGGCGACCACCGAGAnCTACAC
where “n” is allyl-T (a thymine nucleotide
analog having an allyl functionality).

The other primers (PA-PD, shown as non-cleavable primers) mentioned above include:

PA 5′ → 3′
(SEQ. ID. NO. 8)
GCTGGCACGTCCGAACGCTTCGTTAATCCGTTGAG
PB 5′ → 3′
(SEQ. ID. NO. 9)
CGTCGTCTGCCATGGCGCTTCGGTGGATATGAACT
PC 5′ → 3′
(SEQ. ID. NO. 10)
ACGGCCGCTAATATCAACGCGTCGAATCCGCAACT
PD 5′ → 3′
(SEQ. ID. NO. 11)
GCCGCGTTACGTTAGCCGGACTATTCGATGCAGC

While not shown in the example sequences for PA-PD, it is to be understood that any of these primers may include a cleavage site, such as uracil, 8-oxoguanine, allyl-T, etc. at any point in the strand.

Each of the primers 36A, 36B disclosed herein may also include a polyT sequence at the 5′ end of the primer sequence. In some examples, the polyT region includes from 2 T bases to 20 T bases. As specific examples, the polyT region may include 3, 4, 5, 6, 7, or 10 T bases.

The 5′ end of each primer 36A, 36B may also include a linker. Any linker that includes a terminal alkyne group or another suitable terminal functional group that can attach to the surface functional groups of the polymeric hydrogel 34 may be used. In one example, the primers 36A, 36B are terminated with hexynyl functional groups.

As described, primer grafting may be performed before or after the polymeric hydrogel 34 is applied on the substrate 16, 18. In an example, grafting may involve the high-precision method described herein, flow-through deposition, dunk coating, spray coating, puddle dispensing, or by another suitable method that will attach the primer(s) 36A, 36B to the polymeric hydrogel 34 (e.g., that has been applied in depressions 22 within the active region 13).

Each of these example techniques may utilize a primer solution or mixture, which may include the primer(s) 36A, 36B, water, a buffer, and a catalyst. With any of the grafting methods, the primers 36A, 36B react with reactive groups of the polymeric hydrogel 34. When the primers 36A, 36B are grafted after the polymeric hydrogel 34 has been applied to the substrate 16, 18, it is to be understood that the primers 36A, 36B have no affinity for the interstitial regions 24, for the second depressions 15 within the inactive region 19, or for the bonding region(s) 29. As such, the primers 36A, 36B selectively graft to the polymeric hydrogel 34 within the active region 13.

In another example, the polymeric hydrogel 34 may be present in each of the depressions 22. The primers 36A, 36B may be embedded in another polymer (e.g., the same hydrogel material or a different hydrogel material), and the methods described herein may be used to deposit the polymer embedded primers 36A, 36B into the active region 13.

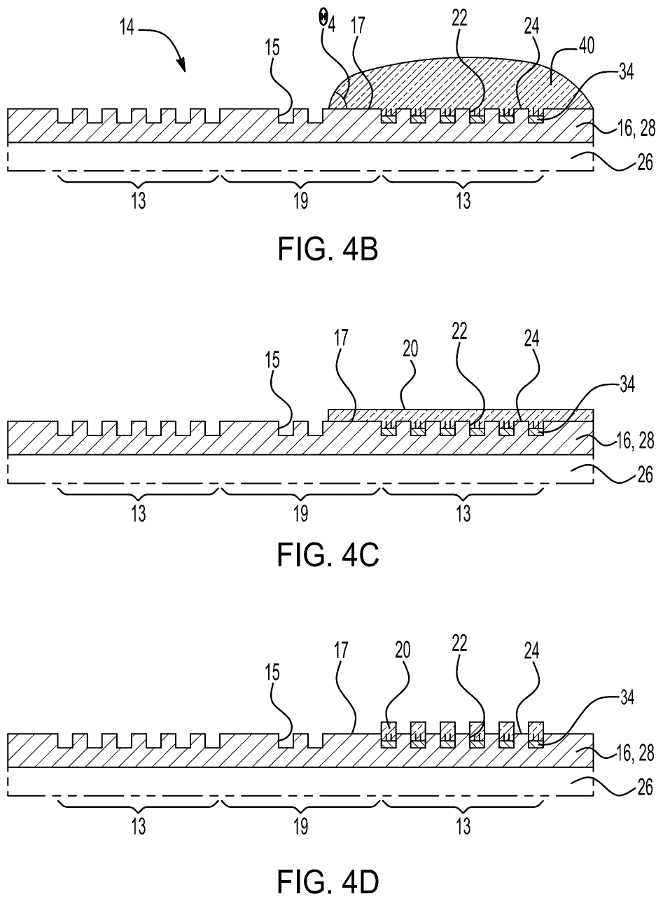

In the examples shown in FIG. 1B and FIG. 1C, the flow cell 10 may also include the protective coating 20 applied over the active region(s) 13. Example high precision methods of applying the protective coating 20 over the active region(s) 13 of the flow cell 10 are described in more detail herein in regard to FIG. 4A through FIG. 4D.

The protective coating 20 generally includes an aqueous solution of a water-soluble protective material that is deposited and left wet, or that is deposited and dried as described in regard to FIG. 4C (e.g., by warming, heating, evaporation, vacuum exposure, convective drying, or the like). The aqueous solution is referred to herein as the water-soluble protective coating solution (as shown at reference numeral 40 in FIG. 4A and FIG. 4B). In some examples, the water-soluble protective coating solution includes up to about 15%, or from about 1% to 15%, or from about 1% to 10%, or from about 1% to 5%, or from about 2% to 5%, or from about 4% to 8%, or from about 5% to 7.5%, or about 5%, or about 7.5% (mass to volume), of the water-soluble protective material. In some examples, the water-soluble protective coating solution includes from about 5% to about 7.5%, or about 5%, or about 7.5% (mass to volume) of the water-soluble protective material.

In addition to water, some examples of the water-soluble protective coating solution may include an alcohol co-solvent to increase the drying rate and decrease the surface tension. Other suitable co-solvents may include low volatility solvents, such as glycerol, to slow down evaporation.

In some examples, the protective coating 20 is at least 95% soluble, e.g., in water, such that the protective coating 20 can be readily removed from active regions 13 of the flow cell 10 prior to amplification and clustering. Examples of the water-soluble protective material that may be used to generate this type of protective coating 20 include polyvinyl alcohol, a polyvinyl alcohol/polyethylene glycol graft copolymer (e.g., KOLLICOAT® IR, available from BASF Corp.), sucrose, chitosan, dextran (e.g., molecular weight of 200,000 Da), polyacrylamide (e.g., molecular weight of 40,000 Da, 200,000 Da, etc.), polyethylene glycol, ethylenediaminetetraacetic acid sodium salt (i.e., EDTA), tris(hydroxymethyl)aminomethane with ethylenediaminetetraacetic acid, (tris(2-carboxyethyl)phosphine), tris(3-hydroxypropyltriazolylmethyl)amine, bathophenanthrolinedisulfonic acid disodium salt, hydroxyl functional polymers, glycerol, and saline sodium citrate.

Any of these water-soluble protective materials may be used in the methods disclosed herein to apply the protective coating with high precision to the active region(s) 13, but not to the bonding region 29 or the inactive region 19.

In some instances, the flow cell 10 further includes a complementary metal oxide semiconductor (CMOS) chip 94 coupled to a bottom of the substrate 16, 18 (through the base support 26), which forms the flow cell 10′ shown in FIG. 2. For ease of illustration, the substrate 16 is shown in FIG. 2. It is to be understood, however, that the multi-layered substrate 18 could be used instead.

As shown in FIG. 2, one example of the flow cell 10′ is attached to the complementary metal oxide semiconductor (CMOS) chip 94. While the flow cell 10′ is shown as the enclosed version with a lid 116 (where the flow channel 12 is defined between the lid 116 and the substrate 16, 18), it is to be understood that an open-wafer form of the flow cell 10′ may be attached to the CMOS chip 94 or an enclosed version with a second patterned structure may be attached to the CMOS chip 94. In the open-wafer forms of the flow cell 10′, the flow channel 12 is defined by one or more active regions 13 of the substrate 16, 18 and no lid or second patterned structure is included.

In this example, the substrate 16 of the flow cell 10′ is positioned over the complementary metal oxide semiconductor chip 94. The substrate 16 includes the active region 13, which includes the plurality of first depressions 22 separated by interstitial regions 24, and the inactive region 19, which includes at least one row of second depressions 15 and the unpatterned fluidic pinning region 17.

In the illustrated example, the substrate 16 of the flow cell 10′ may be affixed directly to, and thus be in physical contact with, the complementary metal oxide semiconductor chip 94 through one or more securing mechanisms (e.g., adhesive, bond, fasteners, and the like). It is to be understood that the substrate 16 may be removably coupled to the complementary metal oxide semiconductor (CMOS) chip 94.

The CMOS chip 94 includes a plurality of stacked layers 96 including, for example, silicon layer(s), dielectric layer(s), metal-dielectric layer(s), metal layer(s), etc.). The stacked layers 96 make up the device circuitry, which includes detection circuitry.

The CMOS chip 94 includes optical components, such as optical sensor(s) 98 and optical waveguide(s) 100. The optical components are arranged such that each optical sensor 98 at least substantially aligns with, and thus is operatively associated with, a single optical waveguide 100 and a single depression 22 of the flow cell 10′. However, in other examples, a single optical sensor 98 may receive photons through more than one optical waveguide 100 and/or from more than one depression 22. In these other examples, the single optical sensor 98 is operatively associated with more than one optical waveguide 100 and/or more than one depression 22.

As used herein, a single optical sensor 98 may be a light sensor that includes one pixel or more than one pixel. As an example, each optical sensor 98 may have a detection area that is less than about 50 μm². As another example, the detection area may be less than about 10 μm². As still another example, the detection area may be less than about 2 μm². In the latter example, the optical sensor 98 may constitute a single pixel. An average read noise of each pixel of the optical sensor 98 may be, for example, less than about 150 electrons. In other examples, the read noise may be less than about 5 electrons. The resolution of the optical sensor(s) 98 may be greater than about 0.5 megapixels (Mpixels). In other examples, the resolution may be greater than about 5 Mpixels, or greater than about 10 Mpixels.

Also as used herein, a single optical waveguide 100 may be a light guide including a cured filter material that i) filters the excitation light 104 (propagating from an exterior of the flow cell 10′ towards the surface chemistry within the flow cell 10′), and ii) permits the light emissions (not shown, resulting from reactions at the depressions 22) to propagate therethrough toward corresponding optical sensor(s) 98. In an example, the optical waveguide 100 may be, for example, an organic absorption filter. As a specific example, the organic absorption filter may filter excitation light 104 of about 532 nm wavelength and permit light emissions of about 570 nm or more wavelengths. The optical waveguide 100 may be formed by first forming a guide cavity in a dielectric layer 106, and then filling the guide cavity with a suitable filter material.

The optical waveguide 100 may be configured relative to the dielectric material 106 in order to form a light-guiding structure. For example, the optical waveguide 100 may have a refractive index of about 2.0 so that the light emissions are substantially reflected at an interface between the optical waveguide 100 and the surrounding dielectric material 106. In certain examples, the optical waveguide 100 is selected such that the optical density (OD) or absorbance of the excitation light 104 is at least about 4 OD. More specifically, the filter material may be selected and the optical waveguide 100 may be dimensioned to achieve at least 4 OD. In other examples, the optical waveguide 100 may be configured to achieve at least about 5 OD or at least about 6 OD.

The flow cell 10′ includes the substrate 16, which is positioned over and attached to the complementary metal oxide semiconductor chip 94. At least a portion of the substrate 16 is in contact with a first embedded metal layer 112 of the CMOS chip 94 and also with an input region 110 of the optical waveguide 100. The contact between the substrate 16 and the first embedded metal layer 112 may be direct contact or may be indirect contact through a shield layer 114.

The substrate 16 may provide one level of corrosion protection for the embedded metal layer 112 of the CMOS chip 94 that is closest in proximity to the substrate 16. Thus, in this example, the substrate 16 functions as a passivation layer. In this example, the substrate 16 may be a passivation material that is transparent to the light emissions resulting from reactions within the depressions 22 (e.g., visible light), and that is at least initially resistant to the fluidic environment and moisture that may be introduced into or present in the flow channel 12. An at least initially resistant material acts as an etch barrier to high pH reagents (e.g., pH ranging from 8 to 14) and as a moisture barrier. Examples of suitable materials for the substrate 16 of the flow cell 10′ include silicon nitride (Si₃N₄), silicon oxide (SiO₂), tantalum pentoxide (TaG₅), hafnium oxide (HfG₂), boron doped p+ silicon, or the like. The thickness of the substrate 16 may vary depending, in part upon the sensor dimensions. In an example, the thickness of the substrate 16 ranges from about 100 nm to about 500 nm.

As described herein, the substrate 16 includes a plurality of depressions 22 separated by interstitial regions 24 (in the active region 13) and the at least one row of second depressions 15 and the fluidic pinning region 17 (in the inactive region 19). In this particular example, the substrate 16 includes one active region 13 flanked by respective inactive regions 19 at the edges 21, 21′.

The depressions 22 in the active region 13 include surface chemistry (e.g., the polymeric hydrogel 34 and at least one primer 36A, 36B attached thereto). In some instances, a protective coating 20 (formed from the protective coating solution disclosed herein) is positioned over each of the depressions 22.

In the example shown in FIG. 2, the enclosed flow cell 10′ also includes a lid 116 that is operatively connected to the substrate 16 to partially define the flow channel 12 between the substrate 16 (and the depressions 22 therein) and the lid 116. The lid 116 may be any material that is transparent to the excitation light 104 that is directed toward the depressions 22. As examples, the lid 116 may include glass (e.g., borosilicate, fused silica, etc.), plastic, etc. A commercially available example of a suitable borosilicate glass is D 263®, available from Schott North America Inc. Commercially available examples of suitable plastic materials, namely cyclo olefin polymers, are the ZEONOR® products available from Zeon Chemicals L.P.

The lid 116 may be physically connected to the substrate 16 through the material 62. In the example shown in FIG. 2, the material 62 is coupled to a portion the surface of the substrate 16 that is part of the bonding region 29. In this example, the inactive region 19 pins any deposited fluids, thus keeping the bonding region 29 free of material and clear for bonding. It is to be understood that in some examples, the inactive regions 19 may be used for bonding. For example, when the methods disclosed herein are used for depositing primers 36A, 36B in the active region 13, the primer solution is removed after primer attachment takes place, and thus does not remain on the inactive regions 19. In these instances, the inactive regions 19 could be used for bonding.

As depicted in FIG. 2, the material 62 may be positioned over or in the depressions 15 and over all or a portion of the fluidic pinning region 17. The material 62 also extends between this/these surface(s) and an interior surface of the lid 116. Alternatively, the substrate 16 may include a bonding region 29 next to the row of second depressions 15 (on the opposite side of the fluidic pinning region 17), and the material 62 may be attached to the bonding region 29. In some examples, the material 62 and the lid 116 may be integrally formed such that they 62, 116 are a continuous piece of material (e.g., glass or plastic). In these examples, a thin layer of adhesive may be used to attach the integrally formed piece to at least a portion of the inactive region 19 or the bonding region 29. In other examples, the material 62 and the lid 116 may be separate components that are coupled to each other. In these other examples, the material 62 may be the same material as, or a different material than the lid 116. In still other examples, the material 62 includes a curable adhesive layer that bonds the lid 116 to the substrate 16 (at a portion of its surface).

In an example, the lid 116 may be a substantially rectangular block having an at least substantially planar exterior surface 118, and an at least substantially planar interior surface 120 that defines a portion of the flow channel 12. The block may be mounted onto the material 62. Alternatively, the block may be etched to define the lid 116 and the material 62 (which functions as sidewall(s)). For example, a recess may be etched into the transparent block. When the etched block is mounted to the substrate 16, the recess may become the flow channel 12.

The lid 116 may include inlet and outlet ports 122, 124 that are configured to fluidically engage other ports (not shown) for directing fluid(s) into the flow channel 12 (e.g., from a reagent cartridge or other fluid storage system component) and out of the flow channel 12 (e.g., to a waste removal system).

In enclosed versions of the flow cell 10′, the flow channel 12 may be sized and shaped to direct a fluid along the depressions 22. The height of the flow channel 12 and other dimensions of the flow channel 12 may be configured to maintain a substantially even flow of the fluid over the depressions 22. The dimensions of the flow channel 12 may also be configured to control bubble formation. In an example, the height of the flow channel 12 may range from about 50 μm to about 400 μm. In another example, the height of the flow channel 12 may range from about 80 μm to about 200 μm. It is to be understood that the height of the flow channel 12 may vary.

Each depression 22 is a localized region in the substrate 16 where a designated reaction may occur.

In an example, each depression 22 is at least substantially aligned with the input region 110 of a single optical waveguide 100. As such, light emissions at the depressions 22 may be directed into the input region 110, through the waveguide 100, and to an associated optical sensor 98. In other examples, one depression 22 may be aligned with several input regions 110 of several optical waveguides 100. In still other examples, several depressions 22 may be aligned with one input region 110 of one optical waveguide 100.

The embedded metal layer 112 may be any suitable CMOS metal, such as aluminum (Al), aluminum chloride (AlCl), tungsten (W), nickel (Ni), or copper (Cu). The embedded metal layer 112 is a functioning part of the CMOS AVdd line, and through the stacked layers 96, is also electrically connected to the optical sensor 98. Thus, the embedded metal layer 112 participates in the detection/sensing operation.

It is to be understood that the other optical sensors 98 and associated components may be configured in an identical or similar manner. It is also to be understood, however, that the CMOS chip 94 may not be manufactured identically or uniformly throughout. Instead, one or more optical sensor 98 and/or associated components may be manufactured differently or have different relationships with respect to one another.

The stacked layer 96 may include interconnected conductive elements (e.g., conductors, traces, vias, interconnects, etc.) that can conduct electrical current. The circuitry may be configured for selectively transmitting data signals that are based on detected photons. The circuitry may also be configured for signal amplification, digitization, storage, and/or processing. The circuitry may collect and analyze the detected light emissions and generate data signals for communicating detection data to a bioassay system. The circuitry may also perform additional analog and/or digital signal processing in the CMOS chip 94.

The CMOS chip 94 may be manufactured using integrated circuit manufacturing processes. The CMOS chip 94 may include multiple layers, such as a sensor base/layer (e.g., a silicon layer or wafer). The sensor base may include the optical sensor 98. When the CMOS chip 94 is fully formed, the optical sensor 98 may be electrically coupled to the rest of the circuitry in the stack layer 96 through gate(s), transistor(s), etc.

As used in reference to FIG. 2, the term “layer” is not limited to a single continuous body of material unless otherwise noted. For example, the sensor base/layer may include multiple sub-layers that are different materials and/or may include coatings, adhesives, and the like. Furthermore, one or more of the layers (or sub-layers) may be modified (e.g., etched, deposited with material, etc.) to provide the features described herein.

The stacked layer 96 also includes a plurality of metal-dielectric layers. Each of these layers includes metallic elements (e.g., M1-M5, which may be, for example, W (tungsten), Cu (copper), Al (aluminum), or any other suitable CMOS conductive material) and dielectric material 106 (e.g., SiO₂). Various metallic elements M1-M5 and dielectric materials 106 may be used, such as those suitable for integrated circuit manufacturing.

In the example shown in FIG. 2, each of the plurality of metal-dielectric layers L1-L6 includes both metallic elements M1, M2, M3, M4, M5 and dielectric material 106. In each of the layers L1-L6, the metallic elements M1, M2, M3, M4, M5 are interconnected and are embedded within dielectric material 106. In some of the metal-dielectric layers L1-L6, additional metallic elements may also be included. Some of these additional metallic elements may be used to address individual pixels through a row and column selector. The voltages at these elements may vary and switch between about −1.4 V and about 4.4 V depending upon which pixel the device is reading out.

The configuration of the metallic elements M1, M2, M3, M4, M5 and dielectric layer 106 in FIG. 2 is illustrative of the circuitry, and it is to be understood that other examples may include fewer or additional layers and/or may have different configurations of the metallic elements M1-M5.

In the example shown in FIG. 2, the shield layer 114 is in contact with at least a portion of the substrate 16. The shield layer 114 has an aperture at least partially adjacent to the input region 110 of the optical waveguide 100. This aperture enables the depressions 22 (and at least some of the light emissions therefrom) to be optically connected to the waveguide 100. It is to be understood that the shield layer 114 may have an aperture at least partially adjacent to the input region 110 of each optical waveguide 100. The shield layer 114 may extend continuously between adjacent apertures.

The shield layer 114 may include any material that can block, reflect, and/or significantly attenuate the light signals that are propagating through the flow channel 12 (or through areas of the flow cell 10′ where surface chemistry is positioned). The light signals may be the excitation light 104 and/or the light emissions from the depressions 22. As an example, the shield layer 114 may be tungsten (W).

It is to be understood that the flow cell 10′ may also be used for optical detection.

A high precision method of depositing surface chemistry (e.g., the polymeric hydrogel 34) on the substrate 16, 18 as part of a process of forming the flow cell 10 or the flow cell 10′ will now be described.

### High Precision Hydrogel Patterning Method

An example of a high precision deposition method involving fluidic pinning is shown in FIG. 3A through FIG. 3E. This example method may be used as part of a process of forming the flow cell 10, 10′ described herein.

The example method shown in FIG. 3A through FIG. 3E generally involves (i) defining the active region 13 in a portion of the substrate 16, 18, the active region 13 including: a plurality of first depressions 22 defined in the portion of the substrate 16, 18; and surface chemistry positioned in the plurality of first depressions 22; and (ii) defining the inactive region 19 in another portion of the substrate 16, 18 that is adjacent to the active region 13, the inactive region 19 including: at least one row of second depressions 15 defined in the substrate 16, 18; and an unpatterned fluidic pinning region 17 positioned between the at least one row and an edge of the active region 13, the unpatterned fluidic pinning region 17 having a predetermined width. In an example, the surface chemistry includes the polymeric hydrogel 34 and at least one primer 36A, 36B grafted thereto.

It is to be understood that the method depicted in FIG. 3A through FIG. 3E may utilize the single layer substrate 16 having depressions 15, 22 defined therein, or the method may utilize the multi-layer substrate 18, where the depressions 15, 22 are defined in the layer 28 that is positioned over the base support 26.

As shown in FIG. 3A, the first depressions 22 are defined in the substrate 16 (or the layer 28 of the substrate 18) within the active region 13. The first depressions 22 may be formed using any suitable patterning technique disclosed herein, such as etching, nanoimprint lithography, or photolithography. In some examples, defining the active region 13 is performed using a working stamp (not shown). The working stamp, when used, includes a negative replica of the first depressions 22 and may be pressed into the substrate 16 (or into the layer 28 of the substrate 18) while the material (e.g., resin) of the substrate is soft. Curing of the material of the substrate 16 may then be performed, e.g., via actinic radiation or heat, with the working stamp in place. Release of the working stamp from the substrate 16 forms the first depressions 22 in the substrate 16 (or the layer 28).

As further shown in FIG. 3A, the second depressions 15 are defined in the substrate 16, 18 within the inactive region 19. The second depressions 15 may be formed using any suitable patterning technique disclosed herein, such as etching, nanoimprint lithography, or photolithography. In some examples, defining the at least one row of second depressions 15 of the inactive region 19 is performed using a working stamp. In these examples, the working stamp includes a negative replica of the second depressions 15 and may be pressed into the substrate 16 (or into the layer 28 of the substrate 18) while the substrate 16 is soft. Curing of the material of the substrate 16 may then be performed, e.g., via actinic radiation or heat, with the working stamp in place. Release of the working stamp from the substrate 16, 18 forms the second depressions 15 in the inactive region 19 of the substrate 16 (or in the inactive region 19 of the substrate 18).

In some instances, the same working stamp that is used to form the first depressions 22 in the active region 13 is used to form the second depressions 15 in the inactive region 19, and the depressions 22, 15 may be formed simultaneously. In this example, the respective negative replicas are separated by a substantially planar region that will define the unpatterned fluidic pinning region 17 in the substrate 16 (or the layer 28 of the substrate 18). In other instances, different working stamps may be used to generate the first depressions 22 in the active region 13 and to generate the second depressions 15 in the inactive region 19, and the depressions 22, 15 can be formed simultaneously or sequentially. When separate working stamps are utilized, their positioning during patterning should account for the desired dimensions for the unpatterned fluidic pinning region 17. Other patterning techniques may be used that can generate depressions 22, 15, where surface chemistry can be introduced into the depressions 22, 15.

The first depressions 22 and the second depressions 15 may have any suitable dimensions (e.g., any of the dimensions of the depressions 22, 15 described in regard to the flow cell 10 of FIG. 1A through FIG. 1C). In a specific example, each of the second depressions 15 in the at least one row of second depressions 15 has a diameter ranging from about 0.1 μm to about 100 μm.

The depressions 22, 15 may be defined in any suitable configuration disclosed herein with regard to the flow cell 10, such that the depressions 22, 15 within a particular region 13, 19 are separated from other depressions 22, 15 within that particular region 13, 19 by a suitable pitch. In an example, at least one second depression 15 in the row of second depressions 15 is separated from another second depression 15 in the row by a pitch ranging from about 350 nm to about 650 nm. The pitch separating individual second depressions 15 in the at least one row of second depressions 15 has been found to affect the pinning range of a fluid, e.g., the range at which a fluid may be pinned within the active region 13 and the fluidic pinning region 17 without overflowing into an undesired region, e.g., the depressions 15, an adjacent active region 13, and/or a bonding region 29.

While not shown in the figures, in some instances, the method further includes activating the portion of the substrate (including the depressions 22) after defining the plurality of first depressions 22 therein and prior to positioning the surface chemistry therein. Activation introduces surface groups that can react with the polymeric hydrogel 34 (to facilitate attachment of the polymeric hydrogel 34 to the substrate 16, 18 surface). In some examples, plasma ashing is used to generate the surface functional groups (e.g., —OH groups). Plasma ashing involves the generation of —OH groups at a surface via exposure of the surface to oxygen plasma. In some other examples, plasma ashing may be performed to activate the substrate 16 within the active region 13, and then silanization may be performed.

Silanization involves the application of a silane or silane derivative over the surface of the substrate 16 or the layer 28. The selection of the silane or silane derivative may depend, in part, upon the polymeric hydrogel 34 that is to be applied. Some example silane derivatives include a cycloalkene unsaturated moiety, such as norbornene, a norbornene derivative (e.g., a (hetero)norbornene including an oxygen or nitrogen in place of one of the carbon atoms), transcyclooctene, transcyclooctene derivatives, transcyclopentene, transcycloheptene, trans-cyclononene, bicyclo[3.3.1]non-1-ene, bicyclo[4.3.1]dec-1 (9)-ene, bicyclo[4.2.1]non-1(8)-ene, and bicyclo[4.2.1]non-1-ene. Any of these cycloalkenes can be substituted, for example, with an R group, such as hydrogen, alkyl, alkenyl, alkynyl, cycloalkyl, cycloalkenyl, cycloalkynyl, aryl, heteroaryl, heteroalicyclyl, aralkyl, or (heteroalicyclyl)alkyl. An example of the norbornene derivative includes [(5-bicyclo[2.2.1]hept-2-enyl)ethyl]trimethoxysilane. Other example silane derivatives include a cycloalkyne unsaturated moiety, such as cyclooctyne, a cyclooctyne derivative, or bicyclononynes (e.g., bicyclo[6.1.0]non-4-yne or derivatives thereof, bicyclo[6.1.0]non-2-yne, or bicyclo[6.1.0]non-3-yne). These cycloalkynes can be substituted with any of the R groups described herein. The method used to apply the silane or silane derivative may vary depending upon the silane or silane derivative that is being used. Examples of suitable silanization methods include vapor deposition (e.g., a YES method), spin coating, or other deposition methods. These methods may silanize the entire substrate 16, 18 surface, and then high precision coating may be used to selectively apply the polymeric hydrogel 34 to the active region 13. Alternatively, the high precision coating may be used to selectively apply the silane or silane derivative to the active region 13.

As shown in FIG. 3B, after the substrate 16, 18 has been patterned (and in some cases, (selectively) activated), the polymeric hydrogel 34 may then be applied over the substrate 16, 18 within the active region 13, such that the polymeric hydrogel 34 begins to spread into the unpatterned fluidic pinning region 17.

The polymeric hydrogel 34 may include any suitable material disclosed herein. In this example method, the polymeric hydrogel 34 may be deposited in the active region 13 using a high precision coating method. In an example, the high precision coating method is performed using the precision gantry tool 68 described with reference to FIG. 5. In other examples, the high precision coating method is performed using stripe coating or patch coating with a slot-die coating tool. The high precision coating method may further be used with other coating methods, such as spray coating or jetting, e.g., via inkjet. As shown in FIG. 3B, during the deposition process, the polymeric hydrogel 34 becomes applied within the depressions 22 and advances onto the unpatterned fluidic pinning region 17 within the inactive region 19, forming a droplet of polymeric hydrogel 34 having a first contact angle θ₁.

As shown in FIG. 3C, the polymeric hydrogel 34 advances further into the pinning region 17 and approaches the first of the at least one row of second depressions 15, i.e., the row that is closest in proximity to the active region 13 having the polymeric hydrogel 34 dispensed thereon. The contact angle of the droplet of polymeric hydrogel 34 increases to a value that is greater than θ₁ and less than or equal to θ₂. This increase in contact angle is a manifestation of the differential surface energy that is created across the (first) depressions 22, the unpatterned fluidic region 17, and the (second) depressions 15. As shown in the figure, the polymeric hydrogel 34 becomes “pinned” at the interface of the unpatterned fluidic pinning region 17 and the depressions 15, where the increase from θ₁ to θ₂ is representative of the actual pinning as a larger volume of fluid is present without the fluid moving into the depressions 15. In other words, the polymeric hydrogel 34 becomes pinned at an interface between the unpatterned fluidic pinning region 17 and the portion of the substrate 16, 18 including the second depressions 15, and thus the polymeric hydrogel 34 does not advance into the depressions 15, or into an adjacent reactive region 13 (not shown in the FIG. 3 series), or into the bonding region 29. The pinning effect is due, at least in part, to the physical modification, i.e., the depressions 15, in the inactive region 19. By incorporating the fluidic pinning region 17 and the depressions 15 next to the depressions 22 of the active region 13, interfaces with differential surface energy are created. In effect, the hydrophobicity of the depressions 15 is higher than hydrophobicity of the fluidic pinning region 17, and this differential creates the pinning interface.

In other examples, the depressions 15 may be removed from the inactive region 19, and thus the adjacent active regions 13 can be separated by the fluidic pinning region 17. In these examples, the fluidic pinning region 17 is configured so that it is more hydrophobic than the active region 13.

After the polymeric hydrogel 34 is pinned within the unpatterned fluidic pinning region 17, it may be exposed to a curing process. Curing may be performed, e.g., via actinic radiation or heat. The polymeric hydrogel 34 may be removed from the fluidic pinning region 17 and from interstitial regions 24 of the substrate 16, 18, e.g., via a polishing process, to generate the structure shown in FIG. 3D.

The polishing process may be performed with a chemical slurry (including, e.g., an abrasive, a buffer, a chelating agent, a surfactant, and/or a dispersant) which can remove the polymeric hydrogel 34 from the interstitial regions 24 and from the unpatterned fluidic pinning region 17 without deleteriously affecting the underlying substrate 16, 18 or the hydrogel 34 within the depressions 22. Polishing may also be performed with a solution that does not include the abrasive particles. The polishing process may also be performed using polishing head(s)/pad(s) or other polishing tool(s). As an example, the polishing head may be a Strasbaugh ViPRR II polishing head.

Cleaning and drying processes may be performed after polishing. The cleaning process may utilize a water bath and sonication. The water bath may be maintained at a relatively low temperature ranging from about 22° C. to about 30° C. The drying process may involve spin drying, or drying via another suitable technique.

Primers 36A, 36B may then be grafted to the polymeric hydrogel 34 within the depression 22 of the active region 13. This is shown in FIG. 3E. The primers 36A, 36B may be grafted using any suitable technique disclosed herein. The primers 36A, 36B may be any suitable pair of primers disclosed herein (e.g., P5 primers, P7 primers, P15 primers, PA-PD primers). As a result of grafting, the primers 36A, 36B will attach, at their 5′ end, to surface functional groups of the polymeric hydrogel 34, and will have no affinity for the exposed surfaces of the substrate 16, 18 (e.g., depressions 15, fluidic pinning region 17, bonding region 29, and interstitial regions 24).

As described, in some instances, the primers 36A, 36B are pre-grafted to the polymeric hydrogel 34, and thus the primers 36A 36B are attached to the polymeric hydrogel 34 before the hydrogel 34 is applied over the substrate 16, 18. In these instances, additional primer grafting is not performed.

It is to be understood that some examples of the method shown in FIG. 3A through FIG. 3E are implemented using two active regions 13. In these examples, the substrate 16, 18 has two active regions 13 defined in different areas, where the two active regions 13 are separated by the inactive region 19; and the method further comprises: using a precision coating process to deposit the polymeric hydrogel 34 in a first of the two active regions 13; using the precision coating process to deposit the polymeric hydrogel 34 in a second of the two active regions 13; and where a fluid edge positional variation of the deposited polymeric hydrogels 34 in each of the first and second active regions 13 is 5 μm or less. It is to be understood that in some of these examples and as shown in FIG. 3A through FIG. 3E, the inactive region 19 that separates the first and second active regions 13 includes a first unpatterned fluidic pinning region 17 adjacent to an edge 21, 21′ of the first active region 13, a second unpatterned fluidic pinning region 17 adjacent to an edge 21, 21′ of the second active region 13, and at least one row of second depressions 15 positioned between the first and second unpatterned fluidic pinning regions 17.

### High Precision Protective Coating Patterning Method

In some examples, the method described in regard to FIG. 3A through FIG. 3E further comprises depositing the protective coating 20 over the active region 13, whereby the protective coating 20 is pinned within the unpatterned fluidic pinning region 17. In other example methods, the polymeric hydrogel 34 may be blanketly deposited and removed from the fluidic pinning region 17 and interstitial regions 24, the primers 36A, 36B may be selectively grafted to the polymeric hydrogel 34 within the depressions 22 using the high precision coating method described herein (i.e., primers 36A, 36B will not graft to within the depressions 15), and then the protective coating 20 may be formed over the active region 13 using the high precision coating method described herein. In any of these examples, the protective coating 20 may be formed as described in FIG. 4A through FIG. 4C.

As shown in FIG. 4A, the water-soluble protective coating solution 40 may be applied over the patterned structure 14, which includes the polymeric hydrogel 34 in the depressions 22 and the primers 36A, 36B grafted to the polymeric hydrogel 34. The protective coating solution 40 may include any of the components described herein, and may be deposited using the high precision coating method described herein. A specific example of a method of applying the protective coating solution 40 utilizes a precision gantry tool 68, which is described in more detail herein in regard to FIG. 5.

The high precision coating method deposits the solution 40 such that it covers the surface chemistry within the active region 13 (e.g., the polymeric hydrogel 34 and the primers 36A, 36B). The coating solution 40 then advances into a portion of the unpatterned fluidic pinning region 17 and forms a droplet of coating solution 40 having a first contact angle θ₃.

As shown in FIG. 4B, the droplet of coating solution 40 advances further into the fluidic pinning region 17 and approaches the first of the at least one row of second depressions 15, i.e., the row that is closest in proximity to the active region 13 having the coating solution 40 dispensed thereon. The contact angle of the droplet of coating solution 40 increases to θ₄ as it advances. A similar pinning effect as described in reference to FIG. 3C is achieved with the droplet of coating solution 40.

In some instances, the pinned protective coating solution 40 remains wet (in liquid form) and is used as the protective coating 20.

In other instances, the method then involves drying the water-soluble protective coating solution 40 to form the protective coating 20, which may be a solid coating or a gel coating depending upon the water-soluble protective material in the solution 40. Drying may be accomplished via air exposure, nitrogen exposure, vacuum, heating (e.g., in an oven), desiccation via exposure to dry air (e.g., humidity removal), or spin drying. FIG. 4C illustrates the resulting dried protective coating 20.

FIG. 4D illustrates an example of the substrate 16, 18 after portions of the dried version of the protective coating 20 are selectively removed from the fluidic pinning region 17 and from the interstitial regions 24. As illustrated, other portions of the dried form of the protective coating 20 remain over portions of the active region 13 after the selective removal is performed.

In one example, the selective removal of the portions of the dried form of the protective coating 20 may involve laser patterning the portions of the protective coating 20 (i.e., the solid coating or the gel coating) over the fluidic pinning region 17 and the interstitial regions 24. Laser patterning effectively ablates the portions of the protective coating 20 that overlie these regions 17, 24. As such, this technique removes the portions of the protective coating 20 that overlie the regions 17, 24, but leaves the portions of the protective coating 20 that overlie the surface chemistry in the active region 13 at least substantially intact. The resulting structure is shown in FIG. 4D.

In another example, the selective removal may involve timed dry etching the dried form of the protective coating 20 (i.e., the solid coating or the gel coating) until the regions 17, 24 are exposed. As examples, the timed dry etch may involve a reactive ion etch (e.g., with CF₄) or a 100% O₂ plasma etch. The timed dry etching is stopped so that the protective coating 20 remains in the depressions 22, but is removed from the fluidic pinning region 17 and the interstitial regions 24. The duration of the timed dry etch depend upon the etch rate of the etching process used and the thickness of the protective coating 20, and may vary for different protective coatings 20.

In still another example, the selective removal of the dried form of the protective coating 20 may involve wet etching (e.g., using a suitable etching solution, such as an acid that does not affect the underlying surface chemistry within the depressions 22).

As depicted in FIG. 4D, the methods result in the active region 13 being coated with the protective coating 20, while the regions 17, 24 are free of the protective coating 20. The substrate 16, 18 may then be bonded to another patterned structure or to a lid at the inactive region(s) 19 and the bonding region 29 (when an enclosed version of the flow cell 10 is being formed). The bond that is formed may be a chemical bond, or a mechanical bond (e.g., using a fastener, etc.).

The processes shown in FIG. 4A through FIG. 4D may be used to deposit or react an entity with the active region 13, and then selectively remove the entity from everyone except the depressions 22.

The structure shown in FIG. 3E or FIG. 4D may then be bonded to another patterned structure or to a lid, when an enclosed version of the flow cell 10 is to be formed.

Any suitable technique, such as laser bonding, diffusion bonding, anodic bonding, eutectic bonding, plasma activation bonding, glass frit bonding, or other methods known in the art may be used to bond two patterned structures or the patterned structure and a lid together.

### Precision Gantry Tool

In some instances, the process described in regard to FIG. 3A and FIG. 4A (e.g., the application of the polymeric hydrogel 34 or the protective coating solution 40) is performed using a precision gantry tool 68. The precision gantry tool 68 is shown schematically in FIG. 5.

While not shown, it is to be understood that the precision gantry tool 68 includes a controller that is to control the components of the tool 68 in response to user input or pre-programmed instructions.

The tool 68 may include a carrier tray 70 to support the substrate 16, 18 having the second depressions 22 and first depressions 15 defined therein.

The precision gantry tool 68 also includes the gantry 72 which is moveable in the X and Y directions with respect to the XY plane of the carrier tray 70. The gantry 72 can move any components attached thereto in the X and Y directions.

Attached to the gantry 72 is a pump 74 with a nozzle 76 that can dispense volumes of fluid at a precise volumetric flow rate. Examples of such fluids include a mixture including the polymeric hydrogel 34 (pre-grafted or not), the water-soluble protective coating solution 40, a primer solution or mixture, other biomolecules, and sequencing reagents. The volumetric flow rate may range from about 0.15 μL/s to about 20 μL/s. In one example, the volumetric flow rate may be 2 μL/s. In another example, the volumetric flow rate ranges from about 0.16 μL/s to about 5 μL/s.

Any suitable pump 74 and nozzle 76 may be used.

In one example, the pump 74 is a progressive cavity pump. Some pumps, such as pressure based pumps, may be less desirable as they lack a dispense rate and they enable little or no control over the thickness of the dispensed material. These pumps can lead to uncontrolled reflow (undesirable spreading) in the X and Y directions, which does not allow for precise dispensing. The progressive cavity pump helps to keep the thickness of the dispensed material at or below 10 μm. In some examples of enclosed flow cells 10, the depth of the flow channel 12 between two patterned structures or a patterned structure and a lid may range from about 75 μm to about 100 μm. In these examples, the progressive cavity pump may be used to generate multiple layers of dispensed material on each of the structures so that the total thickness on the respective structures ranges from less than 37.5 μm to less than 50 μm (so that the dispensed materials do not completely fill the flow channel 12).

In one example, the nozzle 76 is a metal nozzle. Metal nozzles may be particularly desirable, in part because metal nozzles are less susceptible than plastic nozzles to pressure build up, and nozzle expansion as a result of the pressure build up. Nozzle expansion can alter the air gap AG, which can deleteriously affect the meniscus of the material being dispensed, which can lead to undesirable spreading. The shape of the nozzle 76 can also help reduce pressure buildup issues. For example, conical nozzles are less susceptible than cylindrical nozzles to pressure build up. Metal nozzles coated, on the interior and/or on the exterior, with a hydrophobic layer may also be desirable to help prevent clogging. Any suitable hydrophobic material may be used as the coating. Some hydrophobically coated metal nozzles are commercially available.

One specific example of the nozzle 76 is a stainless steel conical nozzle having a tip diameter of 1 mm or less. The gauge of the nozzle 76 may affect the line fidelity of the dispensed material. In the examples disclosed herein, the nozzle gauge ranges from about 17 to about 30. As examples, the 17 gauge nozzle can produce a 1.2 mm line width and the 30 gauge nozzle can produce a 300 μm line width. It is to be understood that while the nozzle 76 shown in FIG. 5 is positioned over a single depression 22 for ease of illustration, the nozzle 76 may be larger than individual depressions 22 and may be positioned over several depressions 22 (e.g., two depressions 22, five depressions 22, ten depressions 22, etc.). As one example, the nozzle may have a diameter of about 1 mm, and thus may cover about 3,300 depressions 22 having a diameter of about 300 nm each.

During the method, the nozzle 76 may be moved in the X and/or Y directions by the gantry 72 (which is operated by the controller), and may also be controlled to move in the Z direction by the controller. A height sensor (not shown) may be mounted to the gantry 72 in order to measure the position of the substrate along the vertically-oriented Z axis for determining a proper dispense height. The dispense height corresponds with an air gap between the tip of the nozzle 76 and the surface of the substrate 16, 18.

Movement of the nozzle 76 allows the polymeric hydrogel 34 (pre-grafted or non-pre-grafted) or the coating solution 40 (i) to be dispensed within the second depressions 22 of the active region 13, (ii) to become pinned within the unpatterned fluidic pinning region 17, and (iii) to be excluded from the portion of the inactive region 19 that includes the second depressions 15.

During the method, the speed of the gantry 72 may be controlled. In an example, linear gantry speed ranges from about 7.5 mm/s to about 350 mm/s may be used.

Also attached to the gantry 72 is a camera 78. An example of the camera 78 is machine vision camera. The camera 78 may be controlled (e.g., by a controller, not shown) to identify locations on the support 14 or structure 18 where dispensing is desirable. The substrate 16, 18 may include fiducials to aid in location identification. “Fiducials” refer to unique points of identification embedded/included in the substrate 16, 18 and may include a fluorescent material, a phosphorescent material, or another suitable identifier.

To dispense a pattern of fluid onto the substrate 16, 18 (and in particular on active region(s) 13) held in the carrier tray 70, the controller first determines the location and orientation of the substrate 16, 18 in the horizontally oriented XY plane in which the substrate generally lies. The camera 78 may scan the substrate 16, 18 and capture visual images of reference fiducials provided on the top surface of the substrate 16, 18 by traveling along a path that moves across pre-programmed locations of the reference fiducials which are known by the controller. Using the captured visual images, the controller can determine the actual location and orientation of the substrate 16, 18 and its features in the XY plane. The height sensor measures the position of the substrate along the vertically-oriented Z axis for determining a proper air gap. The controller then operates the gantry 72 to move the nozzle 76 along the X and Y axes until the applicator is properly positioned in the XY plane over a desired region (e.g., the active region 13) of the substrate 16, 18 positioned below. The nozzle 76 is then lowered along the Z axis until the nozzle tip is positioned at the proper dispensing height with respect to the substrate surface so that the proper air gap is obtained. The pump 74 may be operated in conjunction with the gantry 72 in the X, Y, and or Z directions to dispense the desired pattern. The coordination and relative rates of the pump 74 and the gantry 72 contributes to the pattern fidelity of the dispensed coating. Upon completion of dispensing, the nozzle 76 is then raised back up along the Z axis and moved to an end position, a soaking position, or to another feature for additional dispensing.

The dispensed material may be dried and/or cured, e.g., by warming, heating, evaporation, vacuum exposure, convective drying, or the like.

This example method may also involve maintaining the nozzle 76 in water before and after the dispensing. The water may be located in a reservoir, which provides a soaking position for the nozzle 76 between dispensing steps. This may be particularly desirable for maintaining the health of stainless steel conical nozzles, as it helps to prevent clogging. Soaking may also be desirable when dispensing polymer solutions that may dry out in the nozzle 76 and cause clogging when exposed to air.

In operation, the precision gantry tool 68 may be set at a centerline C of the active region 13 upon which the fluid is to be dispensed, and then moved in the Y direction to dispense the fluid along a portion of (or the entire) active region 13. The addition of the inactive region 19 flanking the edges 21, 21′ of the active region 13, and its fluidic pinning effect, enables the precision gantry tool 68 to be offset (in the X direction) from the centerline C a predetermined distance D. The predetermined distance D that the nozzle 76 can travel while still achieving the desired pinning effect in the inactive region 19 depends, in part, upon the pitch separating the second depressions 15 in the inactive region 19. As an example, when each of the second depressions 15 in the at least one row of second depressions 15 is separated by a pitch ranging from about 600 nm to about 650 nm, the distance D is about 75 μm. As another example, when each of the second depressions 15 in the at least one row of second depressions 15 is separated by a pitch ranging from about 450 nm to about 500 nm, the distance D is about 150 μm. As yet another example, when each of the second depressions 15 in the at least one row of second depressions 15 is separated by a pitch ranging from about 375 nm to about 425 nm, the distance D is about 200 μm. The addition of the inactive region 19 flanking the edges 21, 21′ of the active region 13, and its fluidic pinning effect, also enables variation in the centerline C (from nominal) from one flow cell 10 to another flow cell 10.

### Additional Notes

Reference is made throughout this disclosure to the bonding region 29. In one example, a portion of the substrate 16, 18 along its perimeter is designated as the bonding region 29, i.e., where no active or inactive regions 13, 19 are patterned (i.e., outside the last row of second depressions 15 at the outermost inactive regions 19). This substantially flat portion can be used to bond a second patterned structure or lid, with or without bonding also taking place at one or more of the inactive regions 19 as described herein.

While the high precision coating methods disclosed herein are described in regard to the deposition of the polymeric hydrogel 34 and/or the protective coating solution 40, it is to be understood that these methods may also be used to deposit other materials with a high degree of precision (e.g., within discrete active regions 13 or other desired areas of the substrate 16, 18).

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range, as if such values or sub-ranges were explicitly recited. For example, a range of about 400 nm to about 1 μm (1000 nm), should be interpreted to include not only the explicitly recited limits of about 400 nm to about 1 μm, but also to include individual values, such as about 708 nm, about 945.5 nm, etc., and sub-ranges, such as from about 425 nm to about 825 nm, from about 550 nm to about 940 nm, etc. Furthermore, when “about” and/or “substantially” are/is utilized to describe a value, they are meant to encompass minor variations (up to +/−10%) from the stated value.

While several examples have been described in detail, it is to be understood that the disclosed examples may be modified. Therefore, the foregoing description is to be considered non-limiting.

What is claimed is:

1. A flow cell, comprising:
a substrate;
an active region defined in a portion of the substrate, the active region including:
a plurality of first depressions defined in the portion of the substrate; and
surface chemistry positioned in the plurality of first depressions; and
an inactive region defined in an other portion of the substrate that is adjacent to the active region, the inactive region including:
at least one row of second depressions defined in the substrate; and
an unpatterned fluidic pinning region positioned between the at least one row and an edge of the active region, the unpatterned fluidic pinning region having a predetermined width.

2. The flow cell as defined in claim 1, wherein the predetermined width ranges from about 3 μm to about 100 μm.

3. The flow cell as defined in claim 1, wherein the surface chemistry includes a polymeric hydrogel having at least one primer grafted thereto.

4. The flow cell as defined in claim 3, wherein the portion of the substrate including the plurality of first depressions is silanized.

5. The flow cell as defined in claim 1, wherein each second depression in the at least one row of second depressions has a diameter ranging from about 0.1 μm to about 100 μm.

6. The flow cell as defined in claim 1, wherein each second depression in the at least one row of second depressions is separated from an immediately adjacent second depression in the at least one row by a pitch ranging from about 350 nm to about 650 nm.

7. The flow cell as defined in claim 1, further comprising a complementary metal oxide semiconductor chip coupled to a bottom of the substrate.

8. A method of fluidic pinning, comprising:
defining an active region in a portion of a substrate, the active region including:
a plurality of first depressions defined in the portion of the substrate; and
surface chemistry positioned in the plurality of first depressions;
defining an inactive region in an other portion of the substrate that is adjacent to the active region, the inactive region including:
at least one row of second depressions defined in the substrate; and
an unpatterned fluidic pinning region positioned between the at least one row and an edge of the active region, the unpatterned fluidic pinning region having a predetermined width.

9. The method as defined in claim 8, wherein defining the active region is performed using a working stamp.

10. The method as defined in claim 8, where defining the at least one row of second depressions of the inactive region is performed using a working stamp.

11. The method as defined in claim 8, wherein each second depression in the at least one row of second depressions is separated from an immediately adjacent second depression in the at least one row by a pitch ranging from about 350 nm to about 650 nm.

12. The method as defined in claim 8, wherein the surface chemistry includes a polymeric hydrogel having at least one primer grafted thereto or a polymer having at least one primer embedded therein.

13. The method as defined in claim 12, further comprising silanizing the portion of the substrate after defining the plurality of first depressions therein and prior to positioning the surface chemistry therein.

14. The method as defined in claim 8, wherein each second depression in the at least one row of second depressions has a diameter ranging from about 0.1 μm to about 100 μm.

15. The method as defined in claim 8, wherein:
the substrate has two active regions defined in different areas, where the two active regions are separated by the inactive region;
the method further comprises:
using a precision coating process to deposit a polymeric hydrogel in a first of the two active regions;
using the precision coating process to deposit the polymeric hydrogel in a second of the two active regions; and
a fluid edge positional variation of the deposited polymeric hydrogels in each of the first and second active regions is 5 μm or less.

16. The method as defined in claim 8, wherein defining the active region involves:
imprinting the plurality of first depressions in the portion of the substrate; and
using a precision coating process to deposit a polymeric hydrogel in the depressions.

17. The method as defined in claim 8, further comprising depositing a protective coating over the active region, whereby the protective coating is pinned in the unpatterned fluidic pinning region.
